(19) United States
(12) Patent Application Publication
(10) Pub. No.: US 2025/0233552 A1
(43) Pub. Date: Jul. 17, 2025

(54) SOLAR MODULE FRAME COUPLINGS

(71) Applicant: Nextracker LLC, Fremont, CA (US)

(72) Inventors: Craig Bradley Edward Wildman, Kensington, CA (US); Madeleine Davis Kho, Oakland, CA (US); Ricardo Delgado-Nanez, San Jose, CA (US); Venkata Nitin Mythreya Yadlapalli, Nellore (IN); Alexander W. AU, Oakland, CA (US)

(21) Appl. No.: 19/009,273

(22) Filed: Jan. 3, 2025

Related U.S. Application Data
(60) Provisional application No. 63/621,144, filed on Jan. 16, 2024.
(60) Provisional application No. 63/550,122, filed on Feb. 6, 2024.
(60) Provisional application No. 63/554,254, filed on Feb. 16, 2024.
(60) Provisional application No. 63/567,464, filed on Mar. 20, 2024.

(51) Int. Cl. H02S 30/10; H02S 20/32

(52) U.S. Cl. CPC H02S 30/10; H02S 20/32

(57) ABSTRACT

A self-centering rail includes a first side portion and a second side portion that is opposite the first side portion. The first side portion is configured to couple to a first solar module frame when a first flange of the first solar module frame is received at the first rail clamp and the second rail clamp and when a frame self-centering member of the first solar module frame is received at the first rail self-centering member. The second side portion is configured to couple to a second solar module frame when a second flange of the second solar module frame is received at the third rail clamp and the fourth rail clamp and when a frame self-centering member of the second solar module frame is received at the second rail self-centering member.

### PRIORITY CLAIM

This application claims priority to each of U.S. provisional patent application No. 63/621,144, filed on Jan. 16, 2024, U.S. provisional patent application No. 63/550,122, filed on Feb. 6, 2024, U.S. provisional patent application No. 63/554,254, filed on Feb. 16, 2024, and U.S. provisional patent application No. 63/567,464, filed on Mar. 20, 2024. The entire contents of each of these is hereby incorporated by reference.

### TECHNICAL FIELD

This disclosure relates generally to device, system, and method embodiments of solar module frame couplings. Solar module frame coupling device, system, and method embodiments disclosed herein can be configured to facilitate more efficient and effective installation of one or more solar modules to a support structure, such as a torque tube of a solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application.

### SUMMARY

This disclosure in general describes device, system, and method embodiments of solar module frame coupling apparatuses. Solar module frame coupling device, system, and method embodiments disclosed herein can be configured to facilitate more efficient and effective coupling installation of one or more solar module frames to a support structure. For example, solar module frame coupling device, system, and method embodiments disclosed herein can be configured to facilitate more efficient and effective installation of one or more solar module frames to a torque tube. In some such examples, solar module frame coupling device, system, and method embodiments disclosed herein can be configured to facilitate automated (e.g., autonomous, such as fully or partially robotic) installation of one or more solar modules to a torque tube using one or more solar module frame coupling apparatus embodiments disclosed herein.

One embodiment includes a method for coupling one or more solar module frame(s) to a torque tube. This method embodiment includes landing a first side of a first solar module frame at a first location that is adjacent to a first rail; slidingly coupling the first side of the first solar module at a first rail grabber of the first rail; landing a second side of the first solar module at a second location that is adjacent to a second rail, with the second rail including a slider that is at an installation position; and moving the second rail's slider from the installation position to a coupling position to couple the second side of the first solar module to the second rail (e.g., moving the second rail's slider from the installation position to the coupling position when the first side of the first solar module is engaged at the first rail grabber of the first rail). In a further embodiment, this method can additionally include a step of securing the second rail's slider at the coupling position.

Another embodiment includes a method for coupling one or more solar module frame(s) to a torque tube. This method embodiment includes installing a first wedge washer rail at a torque tube with a first nut of the first wedge washer rail at an installation position; installing second wedge washer rail at the torque tube with a second nut of the second wedge washer rail at an installation position; placing a first side of a first solar module at the first wedge washer rail, with the first nut at the installation position, and placing a second side of the first solar module at the second wedge washer rail, with the second nut at the installation position; and (i) driving the first nut of the first wedge washer rail from the installation position to a coupling position to cause a first wedge washer of the first wedge washer rail to move radially toward the first side of the first solar module, and (ii) driving the second nut of the second wedge washer rail from the installation position to a coupling position to cause a first wedge washer of the second wedge washer rail to move radially toward the second side of the first solar module.

An additional embodiment includes a method for coupling one or more solar module frame(s) to a torque tube. This method embodiment includes installing a first rotary tab rail at a torque tube with one or more rotary locking tab(s) in an unlocked position; placing a first solar module at the first rotary tab rail with the one or more rotary locking tab(s) in the unlocked position; actuating the one or more rotary locking tab(s) of the first rotary tab rail from the unlocked position to a locked position to engage the one or more rotary locking tab(s) with the solar module frame (e.g., with a flange at the solar module frame). As one example, actuating the one or more rotary locking tab(s) can include using a rotary locking tab actuation tool to cause rotation of the one or more locking tab(s) from the unlocked position to the locked position. For instance, when used, the rotary locking tab actuation tool can include gear teeth that are configured to engage (e.g., mesh with) complementary gear teeth at the one or more rotary locking tab(s) and the rotary locking tab actuation tool can be driven to cause torque to be transferred to the one or more rotary locking tab(s) to thereby cause the one or more locking tab(s) to rotate from the unlocked position to the locked position.

A further embodiment includes a method for coupling one or more solar module frame(s) to a torque tube. This method embodiment includes installing a first swing clamp rail at a torque tube with one or more swing clamps of the first swing clamp rail in a disengaged position; placing a first solar module frame at the first swing clamp rail with the one or more swing clamps of the first swing clamp rail in the disengaged position; and actuating a fastener of the first swing clamp rail to cause the one or more swing clamps of the first swing clamp rail to move from the disengaged position to an engaged position. For example, the first swing clamp rail can include a pair of swing clamps, and actuating a fastener of this first swing clamp rail can cause the pair of swing clamps to move from the disengaged position, at which the pair of swing clamps are off of and disengaged from a flange at the first solar module frame, to the engaged position, at which the pair of swing clamps are at and engaged to the flange at the first solar module frame.

Another embodiment includes a method for coupling one or more solar module frame(s) to a torque tube. This method embodiment includes installing a first biased engagement member rail at a torque tube with one or more biased engagement members of the first biased engagement member rail biased to an engagement position; placing a first solar module frame at the first biased engagement member rail to transition the one or more biased engagement members of the first biased engagement member rail from the biased engagement position to a disengaged position (e.g., via a flange of the first solar module frame contacting the one or more biased engagement members of the first biased engagement member rail to overcome a bias of the one or more biased engagement members to the engagement position such that the flange of the first solar module frame urges the one or more biased engagement members to the disengagement position); and aligning one or more flange receiving aperture(s) at the first solar module frame with the one or more biased engagement members of the first biased engagement member rail to transition the one or more biased engagement members of the first biased engagement member rail from the disengaged position to the biased engagement position (e.g., upon alignment between a flange receiving aperture at the first solar module frame and a biased engagement member of the first biased engagement member rail, the bias force at the biased engagement member causes the biased engagement member to move into the flange receiving aperture at the first solar module frame to secure the first solar module frame to the first biased engagement member rail).

An additional embodiment includes biased engagement member rail. This embodiment of the biased engagement member rail includes a rail body. The rail body includes a torque tube interfacing side and a solar module frame receiving side that is opposite the torque tube interfacing side. The tore tube interfacing side can be configured to sit at the torque tube (e.g., configured to directly contact the torque tube via a torque tube interface structure, at the torque tube interfacing side of the rail body, that corresponds to at least a portion of a cross-sectional shape of the torque tube, for instance such that the torque tube interface structure, at the torque tube interfacing side of the rail body is semi-circular). The solar module frame receiving side can include a first frame retention arm along at least a portion of a first longitudinal side portion of the solar module frame receiving side of the rail body and a second frame retention arm along at least a portion of a second longitudinal side portion of the solar module frame receiving side of the rail body (e.g., with the first longitudinal side portion being opposite the second longitudinal side portion). In addition, the solar module frame receiving side of the rail body can include one or more biased engagement members. For example, the solar module frame receiving side of the rail body can include one or more biased engagement members at the first longitudinal side portion of the solar module frame receiving side of the rail body (e.g., adjacent to the first frame retention arm) and one or more biased engagement members at the second longitudinal side portion of the solar module frame receiving side of the rail body (e.g., adjacent to the second frame retention arm). The one or more biased engagement members at the solar module frame receiving side of the rail body can be configured to be biased to an engagement position at which the one or more biased engagement members project outward (e.g., toward the adjacent retention arm) from a frame receiving surface at the solar module frame receiving side of the rail body. When a solar module frame is placed at the solar module frame receiving side of the rail body, the one or more biased engagement members at the solar module frame receiving side of the rail body can be configured to transition from the biased engagement position to a disengaged position at which the one or more biased engagement members retract inward (e.g., away from the retention arm) toward the frame receiving surface (e.g., the one or more biased engagement members are configured to transition from the biased engagement position to a disengaged position when contacting a flange of the solar module frame that is placed at the solar module frame receiving side of the rail body). And, when a flange receiving aperture at the solar module frame is aligned with a biased engagement member at the solar module frame receiving side of the rail body, the one or more biased engagement members at the solar module frame receiving side of the rail body can be configured to transition from the disengaged position back to the biased engagement position (e.g., upon alignment between a flange receiving aperture at the solar module frame and a biased engagement member of the biased engagement member rail, the bias force at the biased engagement member causes the biased engagement member to move to the engaged position by moving into the flange receiving aperture at the solar module frame to secure the solar module frame to the biased engagement member rail).

Another embodiment includes a strap deformable rail. This strap deformable rail embodiment includes a rail body and a strap. The strap is configured to extend around at least a portion of a torque tube. The rail body has a frame receiving surface and a torque tube interfacing surface that is at an opposite side of the rail body from the frame receiving surface. The rail body includes a torque tube coupling aperture extending from the frame receiving surface to the torque tube interfacing surface, and the rail body includes first and second strap receptacles extending from the frame receiving surface to the torque tube interfacing surface. The strap is attached to the rail body at the first strap receptacle and at the second strap receptacle. The rail body is configured such that as a fastening member is driven into the torque tube coupling aperture, the rail body is caused to deform from a pre-installation state to a deformed state as a result of tension applied at the rail body by the strap.

As one example, the strap deformable rail can be configured such that as a fastening member is incrementally driven further into the torque tube coupling aperture at the rail body and further into the torque tube, the strap is configured to apply corresponding, incrementally greater tension force on the rail body to thereby cause the rail body to change shape from that of the pre-installation state to that of the deformed state. For instance, the strap can be configured to apply a first tension force at the rail body at the first strap receptacle and the strap can be configured to apply a second tension force (e.g., in the same direction as the first tension force) at the rail body at the second strap receptacle. The first tension force and the second tension force that the strap can be configured to apply to the rail body can be of a sufficient magnitude to deform the shape of the rail body, such as to deform the shape of the rail body from the pre-installation state to the deformed state. As one such example, the strap can be configured to apply tension to the rail body to cause the rail body to deform from the pre-installation state to the deformed state, where the deformed state includes a first frame coupling aperture, at one longitudinal side of the torque tube coupling aperture, at the rail body moved further away from the torque tube as compared to the location of that first frame coupling aperture in the pre-installation state and a second frame coupling aperture, at another, opposite longitudinal side of the torque tube coupling aperture than the first frame coupling aperture, at the rail body moved further away from the torque tube as compared to the location of that second frame coupling aperture in the pre-installation state.

In a further embodiment of this strap deformable rail, the torque tube coupling aperture can be located at a central longitudinal region of the rail body, the first strap receptacle and one or more solar module frame coupling apertures can be located at a first longitudinal end portion at one side of the torque tube coupling aperture, and the second strap receptacle and one or more solar module frame coupling apertures can be located at a second, opposite longitudinal end portion at another, opposite side of the torque tube coupling aperture.

Another embodiment includes a method for coupling one or more solar module frames to a torque tube using a strap deformable rail. This method embodiment includes placing a strap deformable rail in a pre-installation state at a torque tube; fastening the strap deformable rail to the torque tube to cause the strap deformable rail to deform to a deformed state; and securing one or more solar module frames to the strap deformable rail that is in the deformed state.

Another embodiment includes a self-centering rail system. This self-centering rail system includes a first solar module frame, a second solar module frame, and a self-centering rail. The first solar module frame includes a first flange and a first frame self-centering member included at least at the first flange, and the second solar module frame includes a second flange and a second frame self-centering member included at least at the second flange. The self-centering rail includes a first side portion and a second side portion (e.g., the second side portion being opposite the first side portion). The first side portion includes a first frame support arm, a first rail clamp, a second rail clamp, and a first rail self-centering member. Each of the first rail clamp, the second rail clamp, and the first rail self-centering member is at the first frame support arm. The second side portion includes a second frame support arm, a third rail clamp, a fourth rail clamp, and a second rail self-centering member. Each of the third rail clamp, the fourth rail clamp, and the second rail self-centering member is at the second frame support arm. The first side portion is configured to couple to the first solar module frame when the first flange is received at the first rail clamp and the second rail clamp and when the first frame self-centering member is received at the first rail self-centering member. And the second side portion is configured to couple to the second solar module frame when the second flange is received at the third rail clamp and the fourth rail clamp and when the second frame self-centering member is received at the second rail self-centering member.

In a further embodiment of this system, the first solar module frame includes a first set of retention slots spaced from a first side of the first frame self-centering member at the first flange, and the first solar module frame includes a second set of retention slots spaced from a second, opposite side of the first frame self-centering member at the first flange. The first rail clamp can be spaced from a first side of the first rail self-centering member at the first frame support arm, and the second rail clamp can be spaced from a second, opposite side of the first rail self-centering member at the first frame support arm. In one such example, the first rail clamp, the second rail clamp, and the first rail self-centering member extend out from a top side of the first frame support arm. And, for instance, the self-centering rail can include a bottom side that is opposite the top side of the first frame support arm, and this bottom side of the self-centering rail includes a generally semi-circular cross-sectional geometry configured to receive a torque tube.

In some such embodiments of this system, each of the first rail clamp and the second rail clamp include teeth members, and each of the first set of retention slots and the second set of retention slots include slots extending through the first flange. The teeth members of the first rail clamp can engage the slots of the first set of retention slots extending through the first flange when the first flange is received at the first rail clamp and the second rail clamp and when the first frame self-centering member is received at the first rail self-centering member. The first frame self-centering member can include a slot extending into the first flange, and, as the first rail self-centering member is received at the slot extending into the first flange, the first rail self-centering member is configured to adjust a position of the first solar module frame relative to a torque tube in an east-west direction.

In some such embodiments, the first rail clamp can be radially spaced apart from the first rail self-centering member to define a landing surface radially between the first rail clamp and the first rail-self centering member. The first frame support arm can terminate at a first floating end that defines an outside bound of the first side portion, and the first rail-self centering member can be closer to the first floating end than is the first rail clamp.

Another embodiment includes a self-centering rail. This self-centering rail embodiment includes a first side portion and a second side portion that is opposite the first side portion. The first side portion includes a first frame support arm, a first rail clamp, a second rail clamp, and a first rail self-centering member. Each of the first rail clamp, the second rail clamp, and the first rail self-centering member is at the first frame support arm. The second side portion includes a second frame support arm, a third rail clamp, a fourth rail clamp, and a second rail self-centering member. Each of the third rail clamp, the fourth rail clamp, and the second rail self-centering member is at the second frame support arm. The first side portion is configured to couple to a first solar module frame when a first flange of the first solar module frame is received at the first rail clamp and the second rail clamp and when a frame self-centering member of the first solar module frame is received at the first rail self-centering member. The second side portion is configured to couple to a second solar module frame when a second flange of the second solar module frame is received at the third rail clamp and the fourth rail clamp and when a frame self-centering member of the second solar module frame is received at the second rail self-centering member.

In a further embodiment of this rail, the first rail clamp is spaced from a first side of the first rail self-centering member at the first frame support arm, and the second rail clamp is spaced from a second, opposite side of the first rail self-centering member at the first frame support arm. Similarly, the third rail clamp is spaced from a first side of the second rail self-centering member at the second frame support arm, and the fourth rail clamp is spaced from a second, opposite side of the second rail self-centering member at the second frame support arm. In some such embodiments, the first rail clamp, the second rail clamp, and the first rail self-centering member extend out from a top side of the first frame support arm, and the third rail clamp, the fourth rail clamp, and the second rail self-centering member extend out from a top side of the second frame support arm. For example, the self-centering rail can include a bottom side that is opposite the top side of the first frame support arm and opposite the top side of the second frame support arm, and the bottom side of the self-centering rail can include a generally semi-circular cross-sectional geometry configured to receive a torque tube.

In a further embodiment of this rail, each of the first rail clamp and the second rail clamp include teeth members, and each of the third rail clamp and the fourth rail clamp include teeth members.

In a further embodiment of this rail, the first rail clamp can be radially spaced apart from the first rail self-centering member to define a first landing surface, at the first side portion, radially between the first rail clamp and the first rail-self centering member. Similarly, the third rail clamp can be radially spaced apart from the second rail self-centering member to define a second landing surface, at the second side portion, radially between the third rail clamp and the second rail self-centering member. The first frame support arm can terminate at a first floating end that defines an outside bound of the first side portion, and the first rail-self centering member can be closer to the first floating end than is the first rail clamp. The second frame support arm can terminate at a second floating end that defines an outside bound of the second side portion, and the second rail self-centering member can be closer to the second floating end than is the third rail clamp.

Another embodiment includes a method for coupling a first solar module frame and a second solar module frame to a self-centering rail. This method embodiment includes the steps of: placing the first solar module frame at a first side portion of the self-centering rail with first self-centering member alignment; moving the first solar module frame relative to the self-centering rail to engage one or more rail clamps at the first side portion of the self-centering rail to the first solar module frame; placing a second solar module frame at a second, opposite side portion of the self-centering rail with second self-centering member alignment; and moving the second solar module frame relative to the self-centering rail to engage one or more rail clamps at the second side portion of the self-centering rail to the second solar module frame.

In a further embodiment of this method, placing the first solar module frame at the first side portion of the self-centering rail with first self-centering member alignment can include placing the first solar module frame at the first side portion of the self-centering rail with a first frame self-centering member at the first solar module frame aligned with a first rail self-centering member at the first side portion of the self-centering rail. And, similarly, placing the second solar module frame at the second side portion of the self-centering rail with second frame self-centering member alignment can include placing the second solar module frame at the second side portion of the self-centering rail with a second rail self-centering member at the second side portion of the self-centering rail. For example, placing the first solar module frame at the first side portion of the self-centering rail with first self-centering member alignment can further include placing the first solar module frame at a first landing surface that is at the first side portion and spaced radially between the one or more rail clamps and the first rail self-centering member at the first side portion. And, similarly, placing the second solar module frame at the second side portion of the self-centering rail with second self-centering member alignment can further include placing the second solar module frame at a second landing surface that is at the second side portion and spaced radially between the one or more rail clamps and the second rail self-centering member at the second side portion.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIGS. 2A-2H illustrate one exemplary embodiment of a solar module frame coupling apparatus. FIG. 2A shows a flow diagram of an exemplary embodiment of a method for coupling one or more solar module frame(s) to a torque tube. FIG. 2B shows a perspective view of an example step of the method of FIG. 2A for placing a first side of a first solar module frame adjacent to a first frame retention device, FIG. 2C shows an elevational view of an example step of the method of FIG. 2A for translating the first side of the first solar module frame into engagement with the first frame retention device, FIG. 2D shows a perspective view of the first side of the first solar module frame engaged with the first frame retention device (e.g., via the translating shown at FIG. 2C), FIG. 2E shows a perspective view of a second frame retention device installed at the torque tube, FIG. 2F shows a perspective view of an example step of the method of FIG. 2A for placing a second side of the first solar module frame at or adjacent to the second frame retention device, FIG. 2G shows a perspective view of an example step of the method of FIG. 2A for engaging the second side of the first solar module frame with the second frame retention device, and FIG. 2H shows a perspective view of a slider of the second frame retention device fixed in place once the second side of the first solar module frame is engaged with the second frame retention device.

FIGS. 3A-3F illustrate another exemplary embodiment of a solar module frame coupling apparatus. FIG. 3A shows a perspective of the exemplary embodiment of the solar module frame coupling apparatus. FIG. 3B shows a flow diagram of an exemplary embodiment of a method for coupling one or more solar module frame(s) to a torque tube using the exemplary embodiment of the solar module frame coupling apparatus. FIG. 3C shows an elevational view of the exemplary embodiment of the solar module frame coupling apparatus with a solar module fame placed at opposite sides of the solar module frame coupling apparatus, and FIG. 3D is a close up elevational view of the solar module frame coupling apparatus of FIG. 3C in a module installation configuration. FIG. 3E is a close up elevational view and FIG. 3F is a perspective view of the solar module frame coupling apparatus of FIG. 3C in a module coupling configuration between two solar modules.

FIGS. 4A-4E illustrates a first exemplary embodiment of a grounding contact solar module frame coupling apparatus that includes a grounding contact at a rail component of the grounding contact solar module frame coupling apparatus. FIG. 4A shows a perspective view of a plurality of grounding contact solar module frame coupling apparatuses coupling a plurality of solar modules to a torque tube, FIG. 4B shows an elevational view of the clamp and rail components of one grounding contact solar module frame coupling apparatus with a pair of solar modules coupled to the grounding contact solar module frame coupling apparatus, FIG. 4C shows a perspective view of the rail component of one grounding contact solar module frame coupling apparatus, FIG. 4D shows a perspective view of two clamp components coupled to the rail component of one grounding contact solar module frame coupling apparatus, and FIG. 4E shows a perspective view of one clamp component of the grounding contact solar module frame coupling apparatus in isolation.

FIGS. 5A and 5B illustrates a second exemplary embodiment of a grounding contact solar module frame coupling apparatus that includes a grounding contact at a clamp component of the grounding contact solar module frame coupling apparatus. FIG. 5A shows a perspective view of a clamp component coupled to a rail component of the grounding contact solar module frame coupling apparatus, and FIG. 5B shows in isolation the clamp component with the grounding contact. The second exemplary embodiment of a grounding contact solar module frame coupling apparatus illustrated here at FIGS. 5A-5B can be similar to, or the same as, the first exemplary embodiment of a grounding contact solar module frame coupling apparatus shown at FIGS. 4A-4E excepts that the second exemplary embodiment of a grounding contact solar module frame coupling apparatus illustrated here at FIGS. 5A-5B can include a grounding contact at a clamp component of the grounding contact solar module frame coupling apparatus (e.g., in addition to, or as an alternative to, having a grounding contact at a rail component of the grounding contact solar module frame coupling apparatus).

FIGS. 6A-6L illustrate an exemplary embodiment of a rotary tab rail solar module frame coupling apparatus. FIG. 6A shows a front elevational view and FIG. 6B shows a cross-section of an embodiment of a solar module frame that can be used with the rotary tab rail solar module frame coupling apparatus. FIG. 6C shows a bottom plan view of the rotary tab rail solar module frame coupling apparatus, FIG. 6D shows a close up bottom plan view of an embodiment of a rotary tab rail, FIG. 6E shows a perspective view of the rotary tab rail along with an associated rotary locking tab actuation tool, FIG. 6F shows a close-up perspective view of the rotary tab rail with a pair of locking tabs, FIG. 6G shows a perspective view of an embodiment of a locking tab, FIG. 6H shows a perspective view of an embodiment of the rotary locking tab actuation tool, FIG. 6I shows a perspective view of the rotary tab rail with a pair of locking tabs in an unlocked position, FIG. 6J shows a perspective view of the rotary tab rail with the pair of locking tabs in a locked position, FIG. 6K shows a top plan view of the rotary tab rail with the pair of locking tabs in a locked position that engages with a solar module frame flange, and FIG. 6L shows a flow diagram of an embodiment of a method for coupling one or more solar module frame(s) to a torque tube using the exemplary embodiment of the rotary tab rail solar module frame coupling apparatus.

FIGS. 7A-7F illustrate an exemplary embodiment of a swing clamp rail solar module frame coupling apparatus. FIG. 7A shows a perspective view of an embodiment of a swing clamp rail, FIG. 7B shows a side elevational view and FIG. 7C shows a perspective view of the swing clamp rail with a pair of swing clamps in a disengaged position, FIG. 7D shows a side elevational view and FIG. 7E shows a perspective view of the swing clamp rail with the pair of swing clamps in an engaged position, and FIG. 7F shows a flow diagram of an embodiment of a method for coupling one or more solar module frame(s) to a torque tube using the exemplary embodiment of the swing clamp rail solar module frame coupling apparatus.

FIGS. 8A-8F illustrate an exemplary embodiment of a biased engagement member rail solar module frame coupling apparatus. FIG. 8A shows a perspective view of a solar module frame placed at an embodiment of a biased engagement member rail to couple the solar module frame to a torque tube, FIG. 8B shows a cross-sectional view of the biased engagement member rail solar module frame coupling apparatus for coupling the solar module frame to the torque tube, FIG. 8C shows a bottom perspective view of the solar module frame coupled to the torque tube via the biased engagement member rail, FIG. 8D shows a perspective view of the biased engagement member rail, FIG. 8E shows an end elevational view of the biased engagement member rail, and FIG. 8F shows a flow diagram of an embodiment of a method for coupling one or more solar module frame(s) to a torque tube using the exemplary embodiment of the biased engagement member rail solar module frame coupling apparatus.

FIGS. 9A-9G illustrate an exemplary embodiment of a strap deformable rail solar module frame coupling apparatus that includes a strap deformable rail. FIGS. 9A-9D show an embodiment of a strap deformable rail installed at a torque tube to couple one or more (e.g., a pair of) solar module frames to a torque tube. FIGS. 9A-9D show the strap deformable rail, for instance, after it has been both placed at the torque tube and fastened to the torque tube such that the strap deformable rail of FIGS. 9A-9D is shown in an exemplary deformed state that can result from fastening the strap deformable rail to the torque tube. In particular, FIG. 9A is a side elevational view, parallel to a longitudinal axis of the torque tube, of the strap deformable rail installed at the torque tube and in a deformed state, FIG. 9B is a side elevational view, perpendicular to a longitudinal axis of the torque tube, of the strap deformable rail installed at the torque tube and in a deformed state, FIG. 9C is a perspective view from a bottom side of the solar module frames of the strap deformable rail installed at the torque tube and in a deformed state, and FIG. 9D is a perspective view from a top side of the solar module frame (one solar module frame is removed for ease of visibility) of the strap deformable rail installed at the torque tube and in a deformed state. FIGS. 9E-9F show the same embodiment of the strap deformable rail of FIGS. 9A-9D except that FIGS. 9E-9F show the strap deformable rail placed at the torque tube but prior to deforming the strap deformable rail (e.g., FIGS. 9E-9F show the strap deformable rail after it has been placed at the torque tube but prior to the strap deformable rail being fastened to the torque tube to cause the strap deformable rail to transition to the deformed state). In particular, FIG. 9E shows a side elevational view, parallel to a longitudinal axis of the torque tube, of the strap deformable rail installed at the torque tube and in an exemplary pre-installation state, and FIG. 9F shows a perspective view of the strap deformable rail installed at the torque tube and in the exemplary pre-installation state. FIG. 9G is a flow diagram of an embodiment of a method for coupling one or more solar module frame(s) to a torque tube using the exemplary embodiment of the strap deformable rail.

FIGS. 10A-10O illustrate an exemplary embodiment of self-centering rail system as well as components of this self-centering rail system and a method for installing solar module frames, for instance, using the self-centering rail system. FIG. 10A is a perspective view of the self-centering rail system and FIG. 10B is a side elevational view of the self-centering rail system. FIG. 10C is a perspective view of a self-centering rail and FIG. 10D is a side elevational view of the self-centering rail, for instance, which can be used in the self-centering rail system. FIG. 10E is a side elevational view of a rail clamp prior to installation of the rail clamp at the self-centering rail and FIG. 10F is a side elevational view of the rail clamp of FIG. 10E installed at the self-centering rail. FIG. 10G is a side elevational view of a solar module frame, for instance, which can be used in the self-centering rail system, FIG. 10H is a perspective view of a first side portion of the solar module frame of FIG. 10G, and FIG. 10I is a perspective view of a second, opposite side portion of the solar module frame of FIG. 10G. FIGS. 10J-10N illustrate an exemplary sequence for coupling first and second solar module frames to a torque tube of a solar tracker using the self-centering rail system. And FIG. 10O is a flow diagram of an embodiment of a method for coupling a first solar module frame and a second solar module frame to a self-centering rail (e.g., to couple the first and second solar module frames to a torque tube of a solar tracker using the self-centering rail system).

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

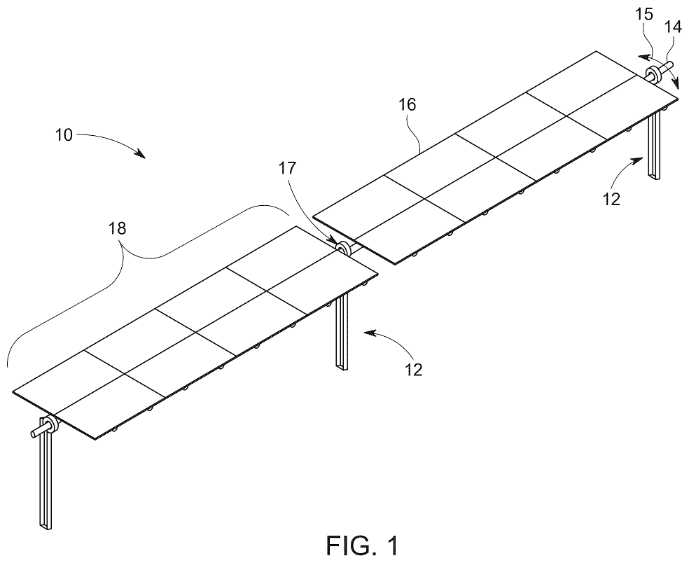

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and be rotatably supported at each pier 12. The solar tracker apparatus 10 can further include a plurality of solar modules 16 (e.g., solar panels having photovoltaic cells) supported at the respective torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, in some instances, the solar module frame 100 can be directly coupled to the torque tube 14 (e.g., for embodiments of the solar module frame 100 that include an integrated rail component) and in other instances the solar module frame 100 can be indirectly coupled to the torque tube 14 by coupling the solar module frame 100 directly to a rail and coupling that rail to the torque tube 14. As will also be described herewith, in various embodiments, adjacent solar module frames 100 of adjacent solar modules 16 can be coupled together. The following disclosure will describe various solar module frame embodiments that can be used, for instance, in a solar tracker apparatus. Such embodiments disclosed herein can be useful in facilitating more labor-efficient solar module frame installation at a solar tracker apparatus and/or reduced material costs by reducing frame material associated with coupling to the torque tube.

Solar module frame coupling device, system, and method embodiments disclosed herein can be configured to facilitate more efficient and effective coupling installation of one or more solar module frames to a support structure. For example, solar module frame coupling device, system, and method embodiments disclosed herein can be configured to facilitate more efficient and effective installation of one or more solar module frames to a torque tube, such as in solar tracker applications, for instance, such as that shown at the example of FIG. 1. These solar module frame coupling embodiments will be discussed as follows in conjunction with the accompanying drawing figures. The illustrated embodiments are examples of the inventive concepts disclosed herein and as such it should be noted that features of various illustrated solar module frame coupling embodiments can be intermixed and combined for certain applications as appropriate.

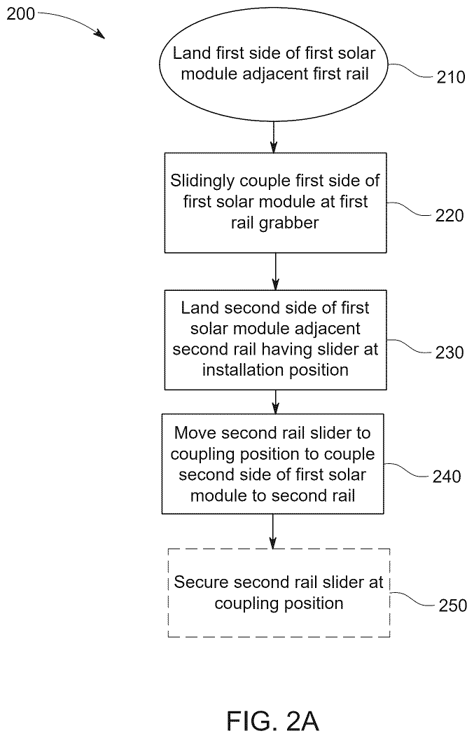

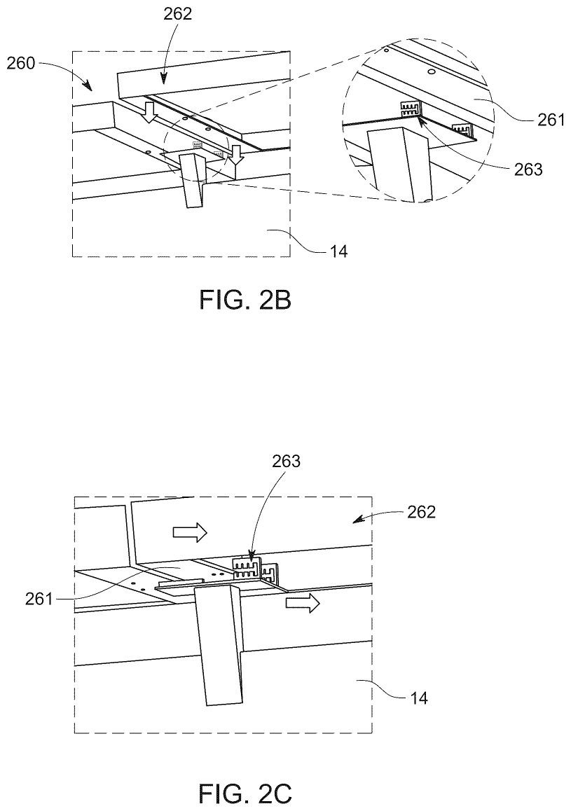

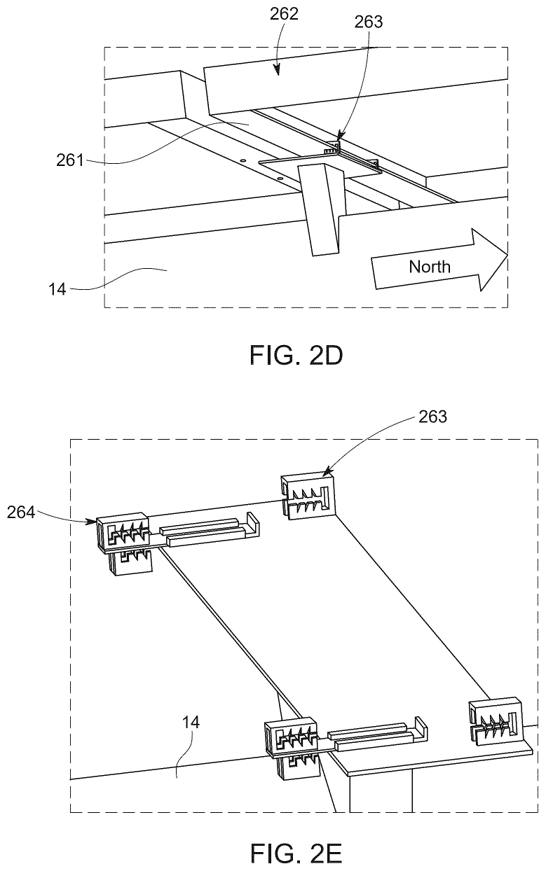

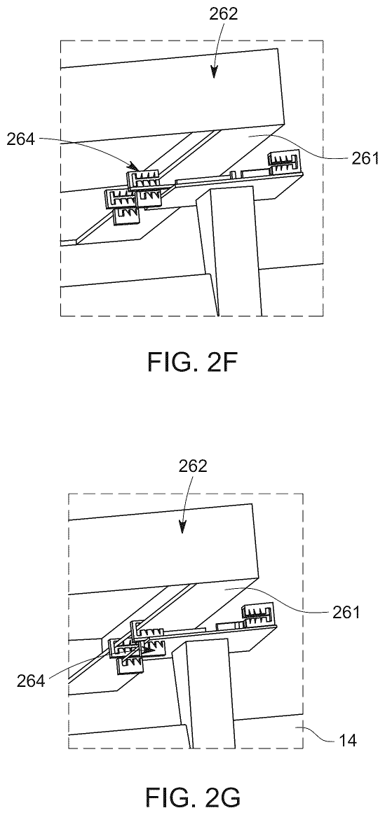

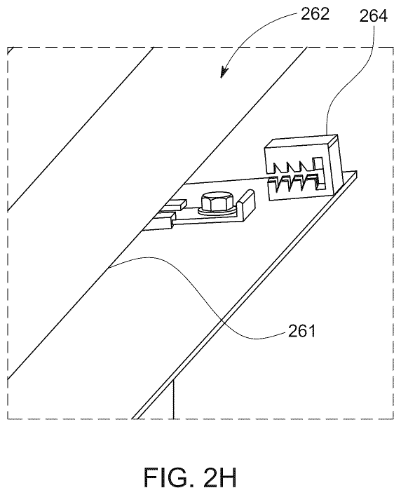

FIGS. 2A-2H illustrate one exemplary embodiment of a solar module frame coupling apparatus 260. FIG. 2A shows a flow diagram of an exemplary embodiment of a method 200 for coupling one or more solar module frame(s) to a torque tube. FIG. 2B shows a perspective view of an example step of the method 200 for landing a first side 261 of a first solar module frame 262 adjacent to a first frame retention device 263, FIG. 2C shows an elevational view of an example step of the method 200 for translating the first side 261 of the first solar module frame 262 into engagement with the first frame retention device 263, FIG. 2D shows a perspective view of the first side 261 of the first solar module frame 262 engaged with the first frame retention device 263 (e.g., via the translating shown at FIG. 2C), FIG. 2E shows a perspective view of a second frame 264 retention device installed at the torque tube, FIG. 2F shows a perspective view of an example step of the method 200 for placing a second side (e.g., that is opposite the first side 261) of the first solar module frame 262 at or adjacent to the second frame retention device 264, FIG. 2G shows a perspective view of an example step of the method 200 for engaging the second side of the first solar module frame 262 with the second frame retention device 264, and FIG. 2H shows a perspective view of a slider of the second frame retention device 264 fixed in place once the second side of the first solar module frame 262 is engaged with the second frame retention device 264.

At step 210, the method 200 includes landing a first side of a first solar module at a first location that is adjacent to a first rail (e.g., FIG. 2B). At step 220, the method 200 includes slidingly coupling the first side of the first solar module at a first rail grabber of the first rail (e.g., FIG. 2C, 2D). At step 230, the method 200 includes landing a second side of the first solar module at a second location that is adjacent to a second rail, with the second rail including a slider that is at an installation position (e.g., 2E, 2F). At step 240, the method 200 includes moving the second rail's slider from the installation position to a coupling position to couple the second side of the first solar module to the second rail (e.g., FIG. 2G) (e.g., moving the second rail's slider from the installation position to the coupling position when the first side of the first solar module is engaged at the first rail grabber of the first rail). The method 200 can, in some application, include a further step 250 of securing the second rail's slider at the coupling position (e.g., FIG. 2H).

The solar module frame coupling apparatus embodiment disclosed at FIGS. 2A-2H can provide useful advantages. For example, it can use a small number of fasteners, such as between zero and two, per solar module; it does not necessitate access to a bottom surface of the solar module; it prevents adding additional stress imparted at a top of a solar module neat the glass material; it can allow walls of solar module frame to flex with the torque tube; it can provide sufficient coupling force and solar module retention at a relatively low cost; and it can allow for quick positional alignment between components.

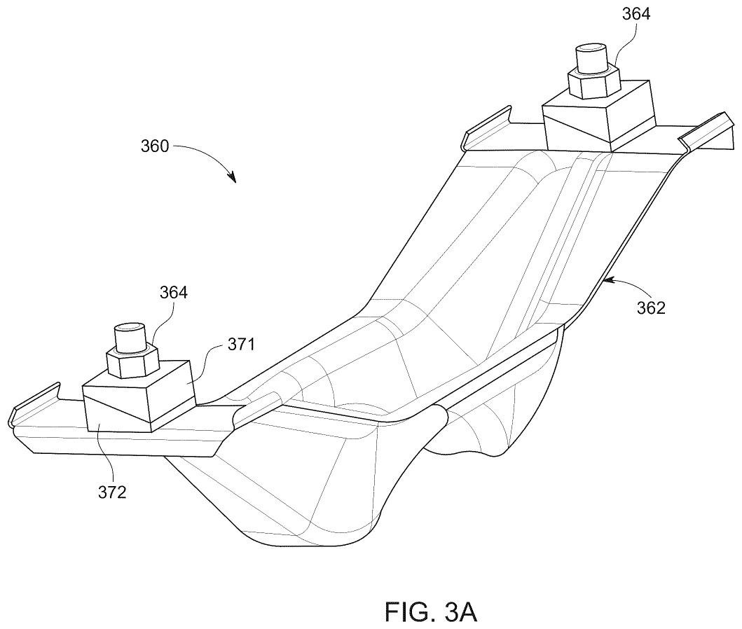

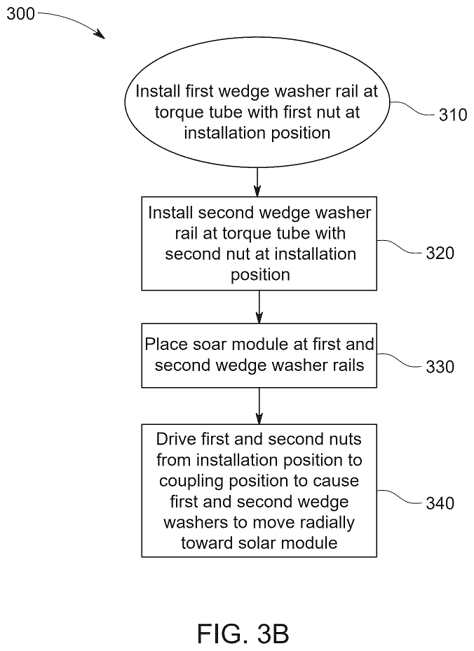

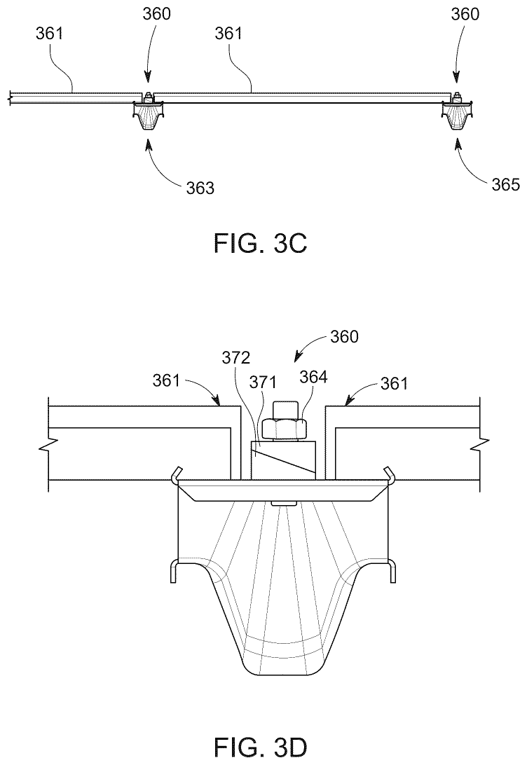

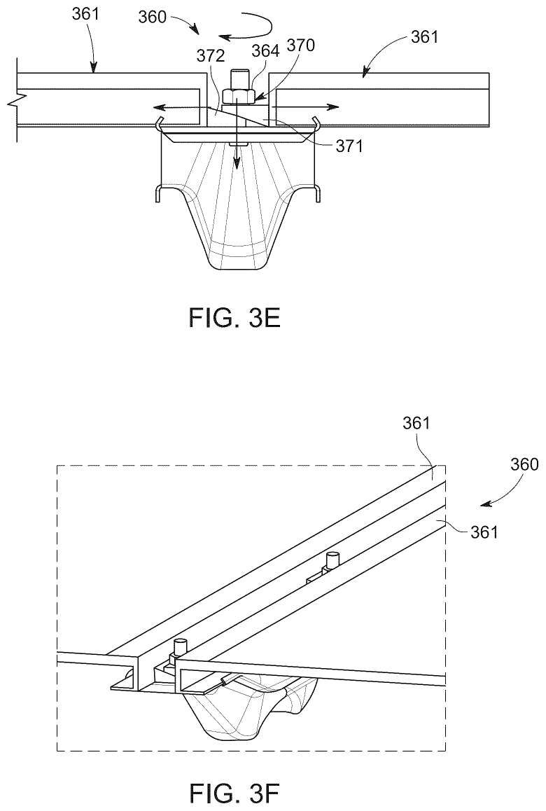

FIGS. 3A-3F illustrate another exemplary embodiment of a solar module frame coupling apparatus 360. FIG. 3A shows a perspective of the exemplary embodiment of the solar module frame coupling apparatus 360. FIG. 3B shows a flow diagram of an exemplary embodiment of a method 300 for coupling one or more solar module frame(s) 361 to a torque tube using the exemplary embodiment of the solar module frame coupling apparatus 360. FIG. 3C shows an elevational view of the exemplary embodiment of the solar module frame coupling apparatus 360 with a solar module fame 361 placed at opposite sides of the solar module frame coupling apparatus 360, and FIG. 3D is a close up elevational view of the solar module frame coupling apparatus 360 in a module installation configuration. FIG. 3E is a close up elevational view and FIG. 3F is a perspective view of the solar module frame coupling apparatus 360 in a module coupling configuration between two solar modules.

At step 310, the method 300 includes installing a first wedge washer rail 362 at a torque tube with a first nut 364 of the first wedge washer rail 362 at an installation position (e.g., FIG. 3C at 363; FIG. 3D). At step 320, the method 300 includes installing second wedge washer rail 362 at the torque tube with a second nut 364 of the second wedge washer rail 362 at an installation position (FIG. 3C at 365; FIG. 3D). At step 330, the method 300 include placing a first side of a first solar module frame 361 at the first wedge washer rail 362, with the first nut 364 at the installation position, and placing a second side of the first solar module frame 361 at the second wedge washer rail 362, with the second nut 364 at the installation position (e.g., FIG. 3C at 363 and 2; FIG. 3D). At step 340, the method 300 includes: (i) driving the first nut 364 of the first wedge washer rail 362 from the installation position to a coupling position 370 to cause a first wedge washer 371 of the first wedge washer rail to move radially toward the first side of the first solar module (e.g., FIG. 3E; 3F), and (ii) driving the second nut of the second wedge washer rail from the installation position to a coupling position to cause a first wedge washer of the second wedge washer rail to move radially toward the second side of the first solar module (e.g., FIG. 3E; 3F).

The solar module frame coupling apparatus embodiment disclosed at FIGS. 3A-3F can provide useful advantages. For example, the wedge washer rail (e.g., FIG. 3A) can be preconfigured so as to ship as one assembled component with the nut and the pair of wedge washers temporarily retained (e.g., via adhesive, etc.) at the body of the wedge washer rail to allow for quick and efficient on-site solar tracker installation. As another example, the wedge washer rail can include one or more (e.g., a pair at each end) retention lips that can help to provide a force counteracting solar module movement in a direction opposite that in which the wedge washer moves radially toward the interfacing solar module.

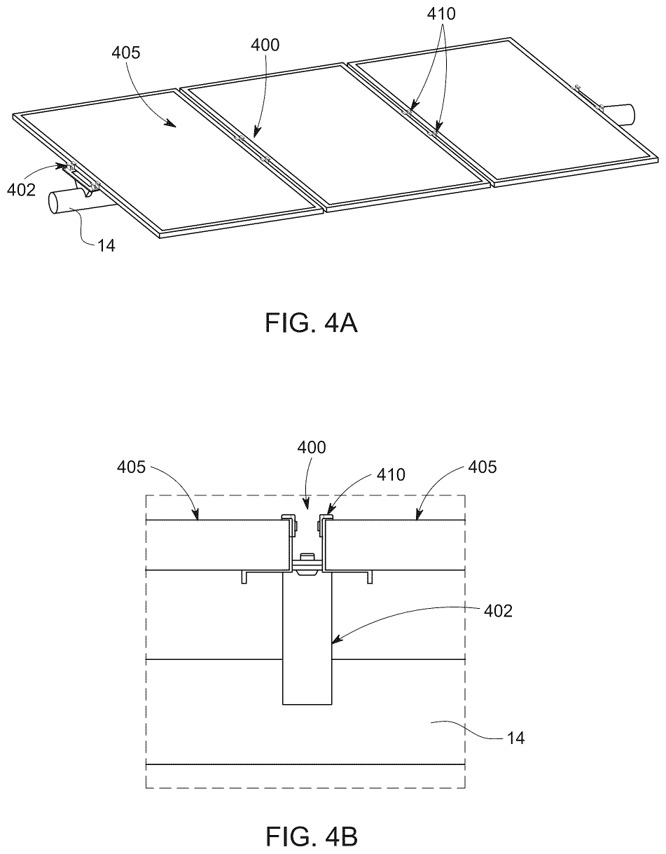

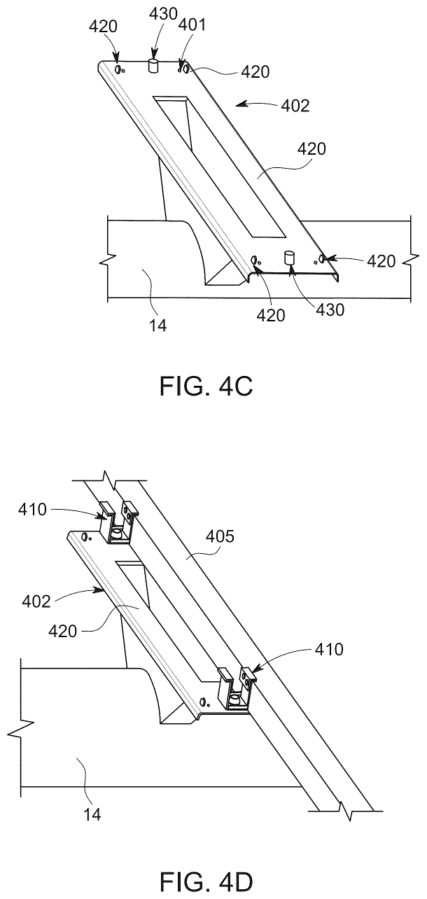

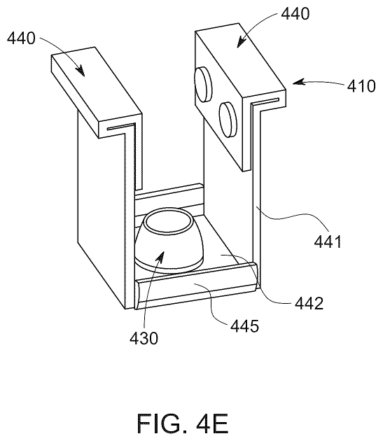

FIGS. 4A-4E illustrates a first exemplary embodiment of a grounding contact solar module frame coupling apparatus 400 that includes a grounding contact 401 at a rail component 402 of the grounding contact solar module frame coupling apparatus 400. FIG. 4A shows a perspective view of a plurality of grounding contact solar module frame coupling apparatuses 400 coupling a plurality of solar modules 405 to torque tube 14, FIG. 4B shows an elevational view of clamp 410 and rail 402 components of one grounding contact solar module frame coupling apparatus 400 with a pair of solar modules 405 coupled to the grounding contact solar module frame coupling apparatus 400, FIG. 4C shows a perspective view of the rail 402 component of one grounding contact solar module frame coupling apparatus, FIG. 4D shows a perspective view of two clamp 410 components coupled to the rail 402 component of one grounding contact solar module frame coupling apparatus 400, and FIG. 4E shows a perspective view of one clamp 410 component of the grounding contact solar module frame coupling apparatus 400 in isolation.

The rail component of the grounding contact solar module frame coupling apparatus can include a landing surface 420 that supports one or more solar module frames 405 (e.g., a pair of solar module frames). This landing surface can include one or more tabs/pins 421 that project out frame the landing surface 420, and these one or more tabs/pins 420 can be configured as locating features to align with holes in the solar module frame. When a solar module frame 405 is placed on the rail component 402, the installer can know it is centered when the tabs/pins protrude 421 into the module frame holes, thereby potentially eliminating the need for alignment in the direction transverse to the torque tube.

Solar modules typically have an aluminum frame with an anodization layer, which happens to an electrical insulator. This layer must be broken to provide electrical grounding. The rail has ground points protruding upward from the landing surface. These are sharp and are designed to cut through the module frame anodization layer when the frame is clamped to the rail. These are part of the rail to save cost, and they are located far from the solar module glass so as to avoid causing stress to the glass.

The clamps can be secured by a fastening mechanism 430, such as nuts and bolts, by lock bolts (bobtails), by a clinch joint, by a flow drill screw, or by other means. If a nut & bolt or a lock bolt are used, the bolt or lock bolt pin can be pre-installed into the rail, pointing upward. If flow drill screw or clinch joint is used, this region would be flat and bare on the rail.

Thus, the clamp 410 component serves to secure a module on one side or on both sides of itself to the rail. The clamp 410 can include two overhangs 440 that land on the top of the module frame and, when the clamp is secured to the rail, apply a preload downward on the module frame toward the rail 402. The overhang 440 can be reinforced for added stiffness as illustrated at the example of FIG. 4E. In the illustrated embodiment at FIG. 4E, the part material is folded back over itself, and clinch joints fasten the folded reinforcement to the overhang. A vertical element 441 can connect the overhang 440 to a base 442. The vertical element 441 can be configured to bend elastically but not stretch. In this way, the vertical element 441 can be configured to allow the torque tube 14 to bend moderately and the vertical element 441 to tilt toward the center of the clamp 410 without transferring lateral forces into the solar module frame.

The clamp base can land on the rail when fastened. It can have stiffeners 445 to help it retain its shape when fastened. A nut or lock bolt collar can be weakly fastened to it for ease of assembly, such as with an adhesive, a captive feature in the base plate, or a tack weld. In some applications, when a tool is applied, the nut or collar can be moved to be secured, but it does not fall off in shipping; alternately, an installer could add it as an additional piece on-site.

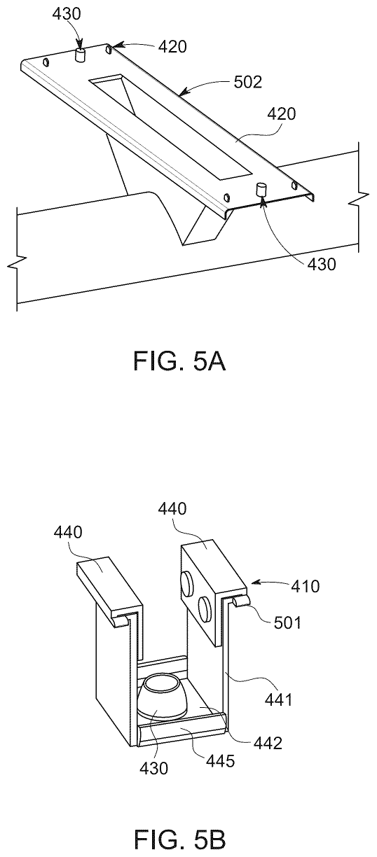

FIGS. 5A and 5B illustrates a second exemplary embodiment of a grounding contact solar module frame coupling apparatus that includes a grounding contact at a clamp component of the grounding contact solar module frame coupling apparatus. FIG. 5A shows a perspective view of a clamp component coupled to a rail component of the grounding contact solar module frame coupling apparatus, and FIG. 5B shows in isolation the clamp component with the grounding contact. The second exemplary embodiment of a grounding contact solar module frame coupling apparatus illustrated here at FIGS. 5A-5B can be similar to, or the same as, the first exemplary embodiment of a grounding contact solar module frame coupling apparatus shown at FIGS. 4A-4E excepts that the second exemplary embodiment of a grounding contact solar module frame coupling apparatus illustrated here at FIGS. 5A-5B can include a grounding contact 501 at a clamp 410 component of the grounding contact solar module frame coupling apparatus (e.g., in addition to, or as an alternative to, having a grounding contact at a rail component of the grounding contact solar module frame coupling apparatus).

As noted, the clamp component embodiment illustrated here at FIGS. 5A-5B can include a grounding contact. The clamp can be U-shaped, and it can be configured to secure a solar module frame on one or both sides. The illustrated clamp component can include two overhangs that land on the top of the solar module frame and when the clamp is secured to the rail can apply a preload downward on the solar module frame toward the rail. The overhang can include one or more sharp grounding contact tabs that can be configured to pierce an anodization layer of an aluminum solar module frame to thereby establishing an electrical ground path. The overhang can be reinforced for added stiffness.

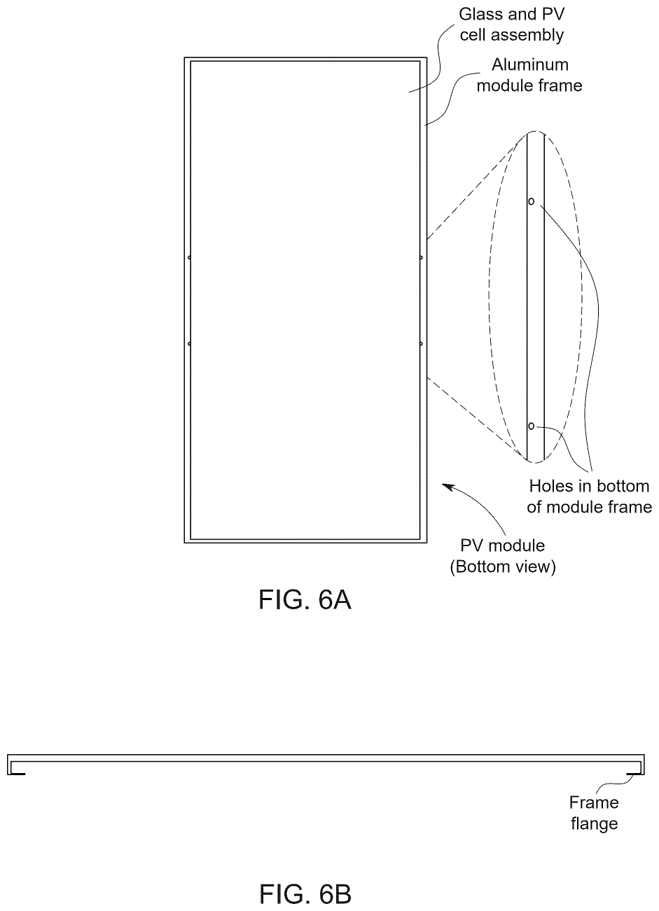

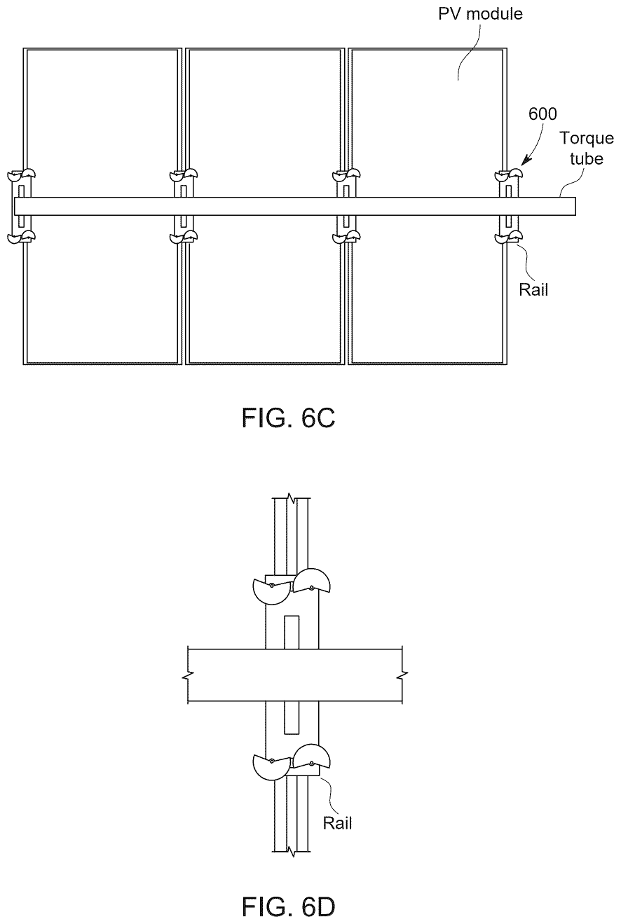

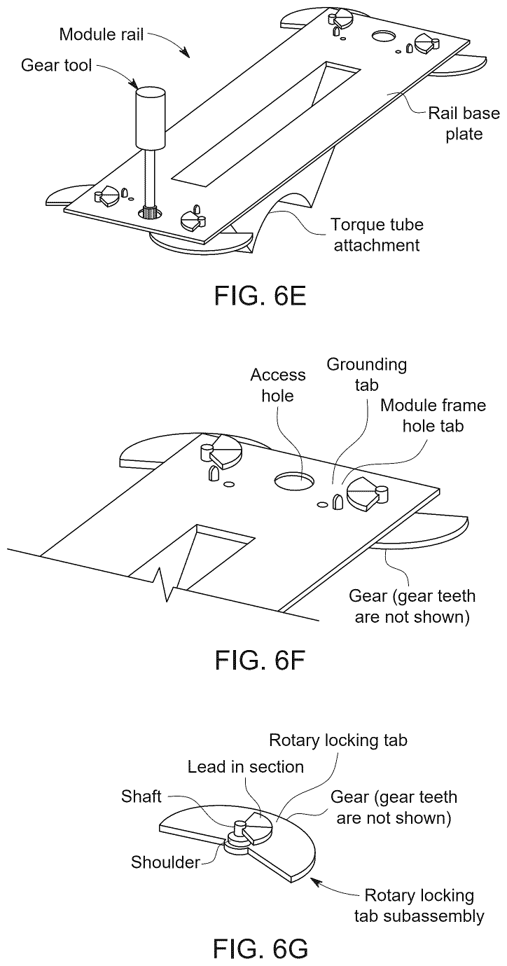

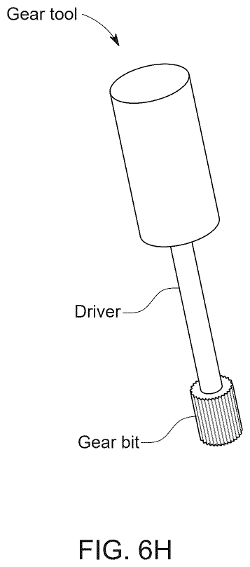

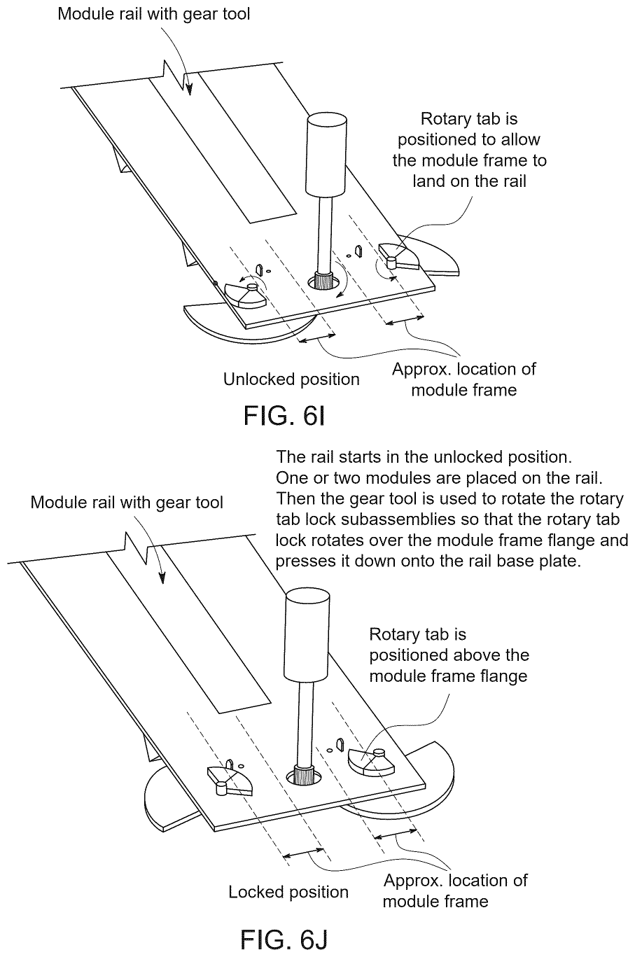

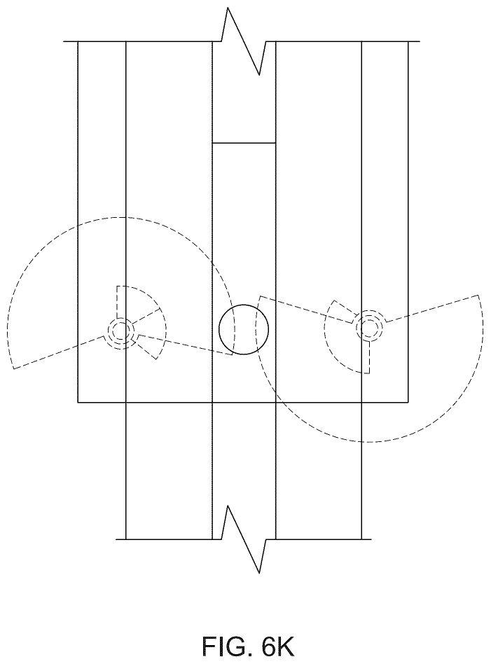

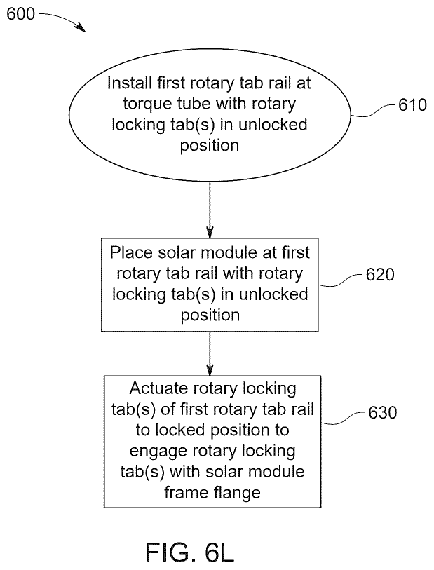

FIGS. 6A-6L illustrate an exemplary embodiment of a rotary tab rail solar module frame coupling apparatus 600. FIG. 6A shows a front elevational view and FIG. 6B shows a cross-section of an embodiment of a solar module frame that can be used with the rotary tab rail solar module frame coupling apparatus. The rotary tab rail solar module frame coupling apparatus embodiment can be applied to a solar module frame with bottom side holes and a bottom side flange also with holes. FIG. 6C shows a bottom plan view of the rotary tab rail solar module frame coupling apparatus, FIG. 6D shows a close up bottom plan view of an embodiment of a rotary tab rail, FIG. 6E shows a perspective view of the rotary tab rail along with an associated rotary locking tab actuation tool, FIG. 6F shows a close-up perspective view of the rotary tab rail with a pair of locking tabs, FIG. 6G shows a perspective view of an embodiment of a locking tab, FIG. 6H shows a perspective view of an embodiment of the rotary locking tab actuation tool, FIG. 6I shows a perspective view of the rotary tab rail with a pair of locking tabs in an unlocked position, FIG. 6J shows a perspective view of the rotary tab rail with the pair of locking tabs in a locked position, FIG. 6K shows a top plan view of the rotary tab rail with the pair of locking tabs in a locked position that engages with a solar module frame flange, and FIG. 6L shows a flow diagram of an embodiment of a method for coupling one or more solar module frame(s) to a torque tube using the exemplary embodiment of the rotary tab rail solar module frame coupling apparatus.

The rotary tab rail solar module frame coupling apparatus embodiment shown at FIGS. 6A-6L can utilize actuation of one or more locking tab(s) (e.g., rotation of one or more locking tab(s) using a rotary locking tab actuation tool) at a rotary tab rail to couple a solar module frame to the rotary tab rail which is secured to the torque tube. This can cause the one or more locking tab(s) to move from an unlocked position to a locked position to, for instance, engage a flange at a solar module frame to secure the solar module frame to the rotary tab rail and thus to the torque tube.

The rotary tab rail can include a bottom portion that is configured to attach to the toque tube and can include a base plate that supports the one or more solar module frames (e.g., a pair of solar module frames supported at the landing surface of the rotary tab rail). The rotary tab rail can include four module frame hole tabs that are configured to go into the holes in the solar module frame. Such tabs can be configured to align the solar modules in the longitudinal and transverse directions with respect to the torque tube. The rotary tab rail can also include one or more grounding tabs. Such one or more grounding tabs can be configured to dig into the solar module frame's anodization coating and to establish an electrical ground path between the rotary tab rail and aluminum solar module frame.

The illustrated embodiment shows that four rotary locking tab subassemblies can be located on the rotary tab rail. These can have a shaft that passes through a hole on the rail base plate. A gear can be located below the base plate. A locking tab with a lead in section can be located above the base plate. The lead in section can be angled upward away from the rotary tab rail.

Two access holes can be located on the base plate between sets of rotary locking tab subassemblies. The access hole an be configured to allow a rotary locking tab actuation tool to pass through the hole from the top of the rotary tab rail to actuate the gears below the rail base plate. The tool can drive two gears at the same time, or it can be designed to drive one gear at a time. The tool can be used to rotate the gear, thereby rotating the rotary locking tab above the flange of the module frame, thereby locking it down onto the rail base plate. The rotary locking tab actuation tool can be used to drive the gears either from below the rail or from above the rail. The tool can include a driver and a bit (e.g., with gear teeth). The bit can have the form of a spur gear with a tooth profile that is compatible with the gear tooth profile on the rotary locking tab subassembly. The bit can have a taper to it to ease engagement with the gearing on the rotary locking tab. The tool can be used in multiple ways, including: as a hand tool driven by muscle power, like a common screwdriver; as a hand tool that is driven by electricity, by compressed air, or by a hydraulic system; and/or as the implement of a robotic assembly system.

The rotary tab rail can start in an unlocked position. Here, for example, the rotary tab can be positioned to allow the module frame to land on the rail. One or two modules are placed on the rail. Then the gear tool is used to rotate the rotary tab lock subassemblies so that the rotary tab lock rotates over the module frame flange and presses it down onto the rail base plate. Here, for example, the rotary tab can be positioned above the module frame flange.

FIG. 6L illustrates one exemplary embodiment of a method associated with, for example, the exemplary embodiment of a rotary tab rail solar module frame coupling apparatus references at FIGS. 6A-6K. At step 610, the method 600 includes installing a first rotary tab rail at a torque tube with one or more (e.g., a pair of) rotary locking tab(s) in an unlocked position (e.g., FIG. 6I). At step 620, the method 600 includes placing a first solar module at the first rotary tab rail with the one or more (e.g., a pair of) rotary locking tab(s) in the unlocked position. At step 630, the method 600 includes actuating the one or more (e.g., a pair of) rotary locking tab(s) of the first rotary tab rail from the unlocked position to a locked position to engage the one or more rotary locking tab(s) with the solar module frame (e.g., with a flange at the solar module frame). As one example, step 630 can include using a rotary locking tab actuation tool to cause rotation of the one or more locking tab(s) from the unlocked position to the locked position. For instance, when used, the rotary locking tab actuation tool can include gear teeth that are configured to engage (e.g., mesh with) complementary gear teeth at the one or more rotary locking tab(s) and the rotary locking tab actuation tool can be driven (e.g., rotated) to cause torque to be transferred to the one or more rotary locking tab(s) to thereby cause the one or more locking tab(s) to rotate from the unlocked position to the locked position.

The disclosed rotary tab rail solar module frame coupling apparatus embodiment can provide a number of useful advantages. For example, the disclosed rotary tab rail solar module frame coupling apparatus embodiment can eliminate the need for fasteners to couple a solar module to the torque tube (e.g., nom fastener needed to couple solar module to rotary tab rail); the solar module can be coupled to the torque tube by simply actuating the locking tab(s) from the top or bottom of the solar module; eliminates additional alignment steps; and/or reduces or eliminates burdensome coupling force stresses on the solar module frame.

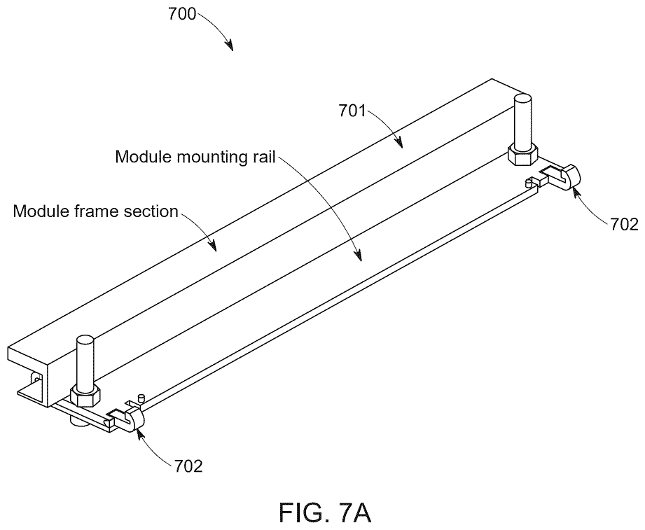

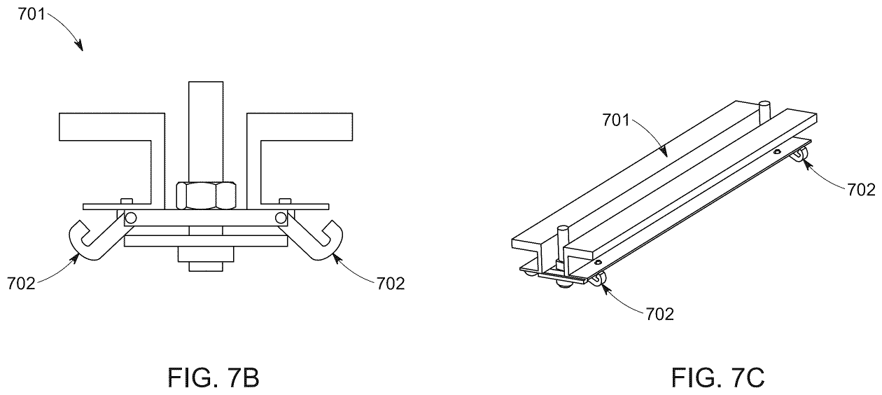

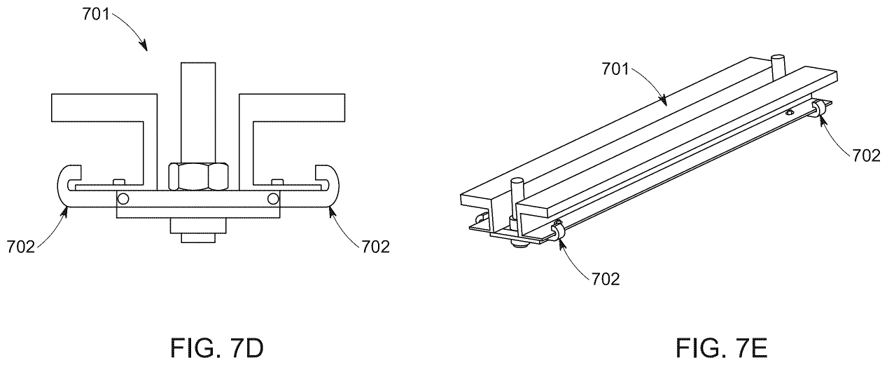

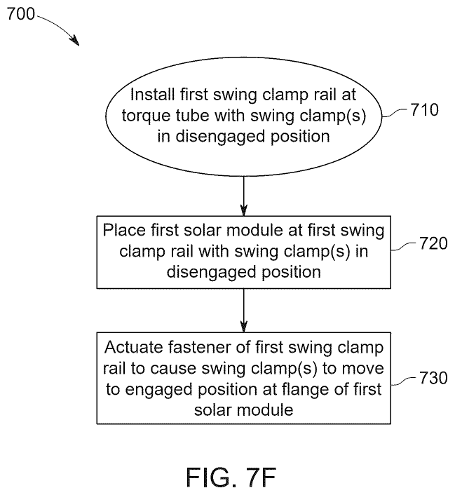

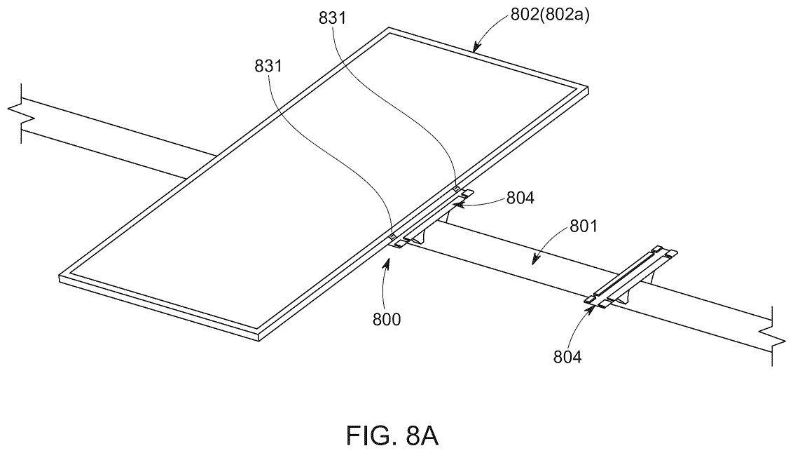

FIGS. 7A-7F illustrate an exemplary embodiment of a swing clamp rail solar module frame coupling apparatus 700. FIG. 7A shows a perspective view of an embodiment of a swing clamp rail 701, FIG. 7B shows a side elevational view and FIG. 7C shows a perspective view of the swing clamp rail with a pair of swing clamps 702 in a disengaged position, FIG. 7D shows a side elevational view and FIG. 7E shows a perspective view of the swing clamp rail with the pair of swing clamps in an engaged position, and FIG. 7F shows a flow diagram of an embodiment of a method 700 for coupling one or more solar module frame(s) to a torque tube using the exemplary embodiment of the swing clamp rail solar module frame coupling apparatus.

For some examples, the swing rail clamp can have a fastener (e.g., a nut and bolt; a bobtail pin and collar; etc.) temporarily adhered to the rail, and a washer can be held (e.g., loosely held) underneath the head of the fastener. As the fastener is tightened, the washer can act to rotate two swing clamps. The two swing clamps can rotate to fit over the bottom of the solar module frame and clamp the bottom of the solar module frame flange against the rail. Studs or tabs in the rail can be used to locate and center the module in an east-west orientation,

At step 710, the method 700 includes installing a first swing clamp rail at a torque tube with one or more swing clamps of the first swing clamp rail in a disengaged position. At step 720, the method 700 includes placing a first solar module frame at the first swing clamp rail with the one or more swing clamps of the first swing clamp rail in the disengaged position. At step 730, the method 700 includes actuating a fastener of the first swing clamp rail to cause the one or more swing clamps of the first swing clamp rail to move from the disengaged position to an engaged position. For example, the first swing clamp rail can include a pair of swing clamps, and actuating a fastener of this first swing clamp rail can cause the pair of swing clamps to move from the disengaged position, at which the pair of swing clamps are off of and disengaged from a flange at the first solar module frame, to the engaged position, at which the pair of swing clamps are at and engaged to the flange at the first solar module frame.

The illustrated example shows the swing clamp rail as including two swing clamps. The two swing clamps can, for instance as illustrated, be positioned at opposite longitudinal end portions of the swing clamp rail and the swing clamps of the swing clamps rail can, for instance as illustrated, rotate in a same direction. In particular, the illustrated embodiment of the swing clamp rail includes the two swing clamps axially aligned along a longitudinal extent of the swing clamp rail body and the two swing clamps pivotally connected to the body of the swing clamps rail. In one such example illustrated here, the swing clamps can have their respect pivot points, relative to the body of the swing rail clamp, axially aligned along the longitudinal extent of the swing clamp rail body and each swing clamp can be radially aligned along a respective radial axis with the fastener at each respective longitudinal end portion of the swing clamp rail.

The swing clamp rail solar module frame coupling apparatus embodiments disclosed with respect to FIGS. 7A-7F can provide useful advantages. For example, the swing clamp rail can be shipped as a single assembly; the solar module frame can be secured to the swing clamp rail without necessitating any external fastener other than the one or more (e.g., integrated) swing clamps; the swing clamp rail can allow for solar module frame installation from the top of the solar module frame; and solar module frame positional and stress tolerance in a north-south direction can be reduced so as to increase useful life.

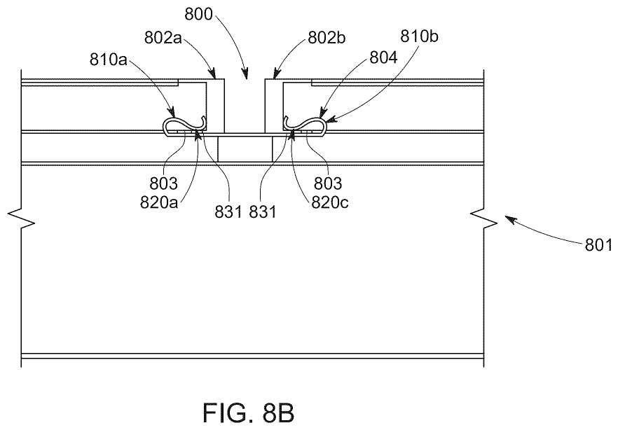

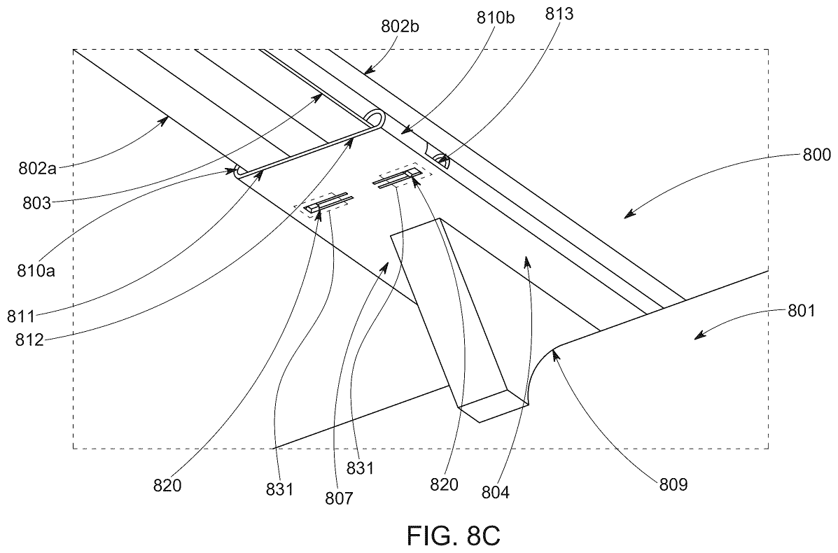

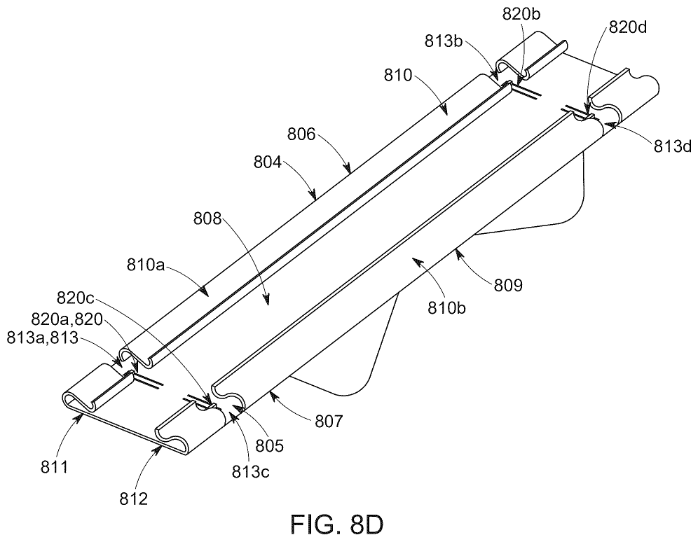

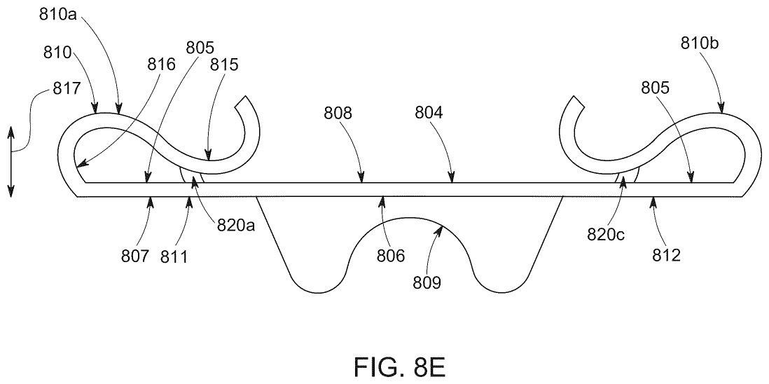

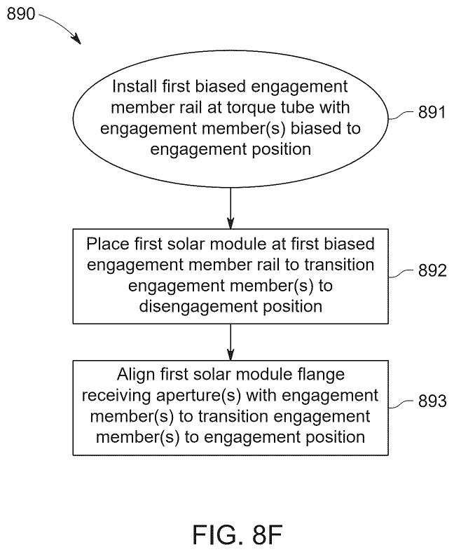

FIGS. 8A-8F illustrate an exemplary embodiment of a biased engagement member rail solar module frame coupling apparatus 800. FIG. 8A shows a perspective view of a solar module frame 802 placed at an embodiment of a biased engagement member rail 804 to couple the solar module frame 802 to a torque tube 801. FIG. 8B shows a cross-sectional view of the biased engagement member rail solar module frame coupling apparatus 800 for coupling one or more the solar module frames 802a, 802b to the torque tube 801 using the biased engagement member rail 804. FIG. 8C shows a bottom perspective view of the solar module frame 802 coupled to the torque tube 801 via the biased engagement member rail 804. FIG. 8D shows a perspective view of the biased engagement member rail 804 in isolation, and FIG. 8E shows an end elevational view of the biased engagement member rail 804 in isolation. FIG. 8F shows a flow diagram of an embodiment of a method 890 for coupling one or more solar module frame(s) to a torque tube, for instance, using the exemplary embodiment of the biased engagement member rail solar module frame coupling apparatus 800.

As seen best at FIGS. 8C-8E, the biased engagement member rail 804 includes a rail body 806. The rail body 806 includes a torque tube interfacing side 807 and a solar module frame receiving side 808 that is opposite the torque tube interfacing side 807. The tore tube interfacing side 807 can be configured to sit at the torque tube 801. As one such example, the tore tube interfacing side 807 can be configured to directly contact the torque tube 801 via a torque tube interface structure 809 at the torque tube interfacing side 807 of the rail body 806. For instance, the torque tube interface structure 809 at the torque tube interfacing side 807 of the rail body 806 can correspond to at least a portion of a cross-sectional shape of the torque tube 801. The illustrated embodiment shows one such example where the torque tube interface structure 809 at the torque tube interfacing side 807 is semi-circular to corresponds to a portion of a circular cross-section of the torque tube 801.

The biased engagement member rail 804, according to some embodiments, such as the example illustrated here, can be formed from a single sheet of material (e.g., a single sheet of metal material, such as aluminum or steel). The single sheet of material can be bent or otherwise shaped into the illustrated configuration of the biased engagement member rail 804 as shown here. As such, the biased engagement member rail 804, including the various portions described herein, can be an integral component shaped from a common, single piece of material.

The biased engagement member rail 804 can include one or more frame retention arms 810. In particular, the biased engagement member rail 804 can include at least a portion of one or more frame retention arms 810 at the solar module frame receiving side 808. Each frame retention arm 810 can be configured to contact a solar module frame 802 and act to apply one or more retention forces at the solar module frame 802 to thereby couple the solar module frame 802 to the torque tube 801. The illustrated biased engagement member rail 804 can be configured to couple two solar module frames 802a, 802b to the torque tube 801 and, as such, the illustrated embodiment of the biased engagement member rail 804 includes two frame retention arms—first frame retention arm 810a and second frame retention arm 810b. The rail body 806 can have a first longitudinal side portion 811 at the solar module frame receiving side 808 and a second longitudinal side portion 812 at the solar module frame receiving side 808, with the first longitudinal side portion 811 being opposite the second longitudinal side portion 812. The first frame retention arm 810a can be located along at least a portion of the first longitudinal side portion 811 at the solar module frame receiving side 808, and the second frame retention arm 810b can be located along at least a portion of the second longitudinal side portion 812 of the solar module frame receiving side 808. The illustrated example of the biased engagement member rail 804 shows the frame retention arms 810a, 810b present at each end of each longitudinal side portion 811, 812. The illustrated embodiment also shows that each frame retention arm 810a, 810b can include one or more engagement gaps 813. For example, the first frame retention arm 810a can include at least one engagement gap 813 along its length between end portions of the first longitudinal side portion 811 and the second frame retention arm 810b can include at least one engagement gap 813 along its length between end portions of the second longitudinal side portion 812. The illustrated embodiment shows that the first frame retention arm 810a includes first engagement gap 813a adjacent a first end portion of the first longitudinal side portion 811 and second engagement gap 813b adjacent a second end portion of the first longitudinal side portion 811, and the illustrated embodiment shows that the second frame retention arm 810b includes third engagement gap 813c adjacent a first end portion of the second longitudinal side portion 812 and fourth engagement gap 813d adjacent a second end portion of the second longitudinal side portion 812.

As noted, the one or more frame retention arms 810 can be configured to apply one or more retention forces at a respective solar module frame 802 to retain the solar module frame 802 in place. For example, each of the first and second frame retention arms 810a, 810b can be configured as a resilient component with a retention force applicator end portion 815 and a base portion 816. The base portion 816 can extend out from the solar module frame receiving side 808, and the retention force applicator end portion 815 can be configured to apply one or more retention forces to help to maintain the solar module frame 802 at the biased engagement member rail 804. Each of the retention arms 810a, 810b can be configured such that the retention force applicator end portion 815 is biased to a retention position, such as that shown at FIG. 8E, and each of the retention arms 810a, 810b can be configured such that, upon application of an actuation force at the retention force applicator end portion 815, the retention force applicator end portion 815 is configured to overcome the bias and move (e.g., flex) in the direction 817 such that the retention force applicator end portion 815 moves away from the solar module frame receiving side 808 to allow solar module frame 802 to be placed between the respective retention arms 810a, 810b and the solar module frame receiving side 808 at the biased engagement member rail 804. Then once the actuation force is removed from the retention force applicator end portion 815 (e.g., and once the solar module frame 802 is placed between the respective retention arms 810a, 810b and the solar module frame receiving side 808), the bias force at the retention force applicator end portion 815 can cause the retention force applicator end portion 815 to move back toward the solar module frame receiving side 808 to the retention position, such as that shown at FIG. 8E. Thus, the retention force applicator end portion 815 can be further away from the solar module frame receiving side 808 when the actuation force is applied (e.g., when the retention force applicator end portion 815 is in a frame installation position) than when the retention force applicator end portion 815 is at the retention position. To help provide such resilient, biased retention arms 810a, 810b that are configured to move between retention and frame installation positions, the illustrated embodiment shows the retention arms 810a, 810b shaped as hook-type members with an arch, which can define a convex curvature with respect to the solar module frame receiving side 808, such as shown at FIG. 8E, extending between the base portion 816 and the retention force applicator end portion 815.

The biased engagement member rail 804 can further include one or more biased engagement members 820. Each of the biased engagement members 820 can be configured to engage one or more solar module frames 802 and act to apply one or more retention forces at the one or more solar module frames 802 to thereby couple the one or more solar module frames 802 to the torque tube 801. The biased engagement member rail 804 can include at least a portion of one or more biased engagement members 820 at the solar module frame receiving side 808. For example, the solar module frame receiving side 808 of the rail body 806 can include one or more biased engagement members 820 at the first longitudinal side portion 811 (e.g., adjacent to the first frame retention arm 810a) and one or more biased engagement members 820 at the second longitudinal side portion 812 (e.g., adjacent to the second frame retention arm 810b). The illustrated embodiment shows two biased engagement members 820a, 820b at the first longitudinal side portion 811 and two biased engagement members 820c, 820d at the second longitudinal side portion 812. In particular, the biased engagement members 820 can be located in alignment with the engagement gaps 813 at the respective, adjacent retention arms 810a, 810b. As shown here, a first biased engagement member 820a can be axially aligned with the first engagement gap 813a at the first frame retention arm 810a and a second biased engagement member 820b can be axially aligned with the second engagement gap 813b at the first frame retention arm 810a, and a third biased engagement member 820c can be axially aligned with the third engagement gap 813c at the second frame retention arm 810b and a fourth biased engagement member 820d can be axially aligned with the fourth engagement gap 813d at the second frame retention arm 810b.

The one or more biased engagement members 820 can be configured to be biased to an engagement position. For example, FIGS. 8D and 8E show one example engagement position of the biased engagement members 820 where the biased engagement members 820 can project outward (e.g., in the direction 817 away from the frame receiving surface 805 at the solar module frame receiving side 808 and toward the respective retention arm 810a, 810b) from a frame receiving surface 805 at the solar module frame receiving side 808. When a solar module frame 802 is placed at the solar module frame receiving side 808, the one or more biased engagement members 820 at the solar module frame receiving side 808 can be configured to transition (e.g., in the direction 817) from the biased engagement position to a disengaged position. For example, at the disengaged position, the one or more biased engagement members 820 can be retracted inward (e.g., in the direction 817 toward the frame receiving surface 805 at the solar module frame receiving side 808 and away the respective retention arm 810a, 810b) toward the torque tube interfacing side 807. Then, when the solar module frame 802 is moved into a position relative to the solar module frame receiving side 808 at the rail 804 to remove contact between the solar module frame 802 and the one or more biased engagement members 820, the bias force on the one or more biased engagement members 820 can act to urge the one or more biased engagement members 820 back to the biased engagement position.

For example, the solar module frame 802 can include a frame flange 803, and the frame flange 803 can include one or more flange receiving apertures 831. For example, the solar module frame 802 as illustrated in this example includes two flange receiving apertures 831 spaced apart from one another along a longitudinal length of the flange 803. The one or more biased engagement members 820 can be configured to transition from the biased engagement position to a disengaged, retracted position when contacting the frame flange 803. Thus, as the frame flange 803 is landed at the solar module frame receiving side 808, the frame flange 803 can be moved into contact with the one or more biased engagement members 820 which can act, upon contact with the frame flange 803, to move the biased engagement members 820a, 820b from the biased engagement position to the disengaged, retracted position. Thus, the frame flange 803 can overcome the bias force at the one or more biased engagement members 820 when the frame flange 803 is in contact with the one or more biased engagement members 820 to cause the one or more biased engagement members 820 to move to the disengaged, retracted position. Then, when contact between the frame flange 803 and the one or more biased engagement members 820 is removed, the bias force at the one or more biased engagement members 820 can act to urge the one or more biased engagement members 820 back to the biased engagement position. For example, when the flange receiving apertures 831 at the solar module frame 802 are aligned with the respective, biased engagement members 820a, 820b at the solar module frame receiving side 808, these biased engagement members 820a, 820b can be configured to transition from the disengaged position back to the biased engagement position (e.g., upon axial alignment between the respective flange receiving aperture 831 at the solar module frame flange 803 and biased engagement member 820a, 820b, the bias force at the biased engagement member 820a, 820b causes the biased engagement member 820a, 820b to move to the engaged position by moving into the respective, aligned flange receiving aperture 831 at the solar module frame flange 803 to secure the solar module frame 802 to the biased engagement member rail 804).

As noted, the biased engagement members rail 804 can be configured to couple two solar module frames 802a, 802b to the torque tube 801, such as shown at the example of FIG. 8B. Referring to FIG. 8B, as the frame flange 803 of frame 802a is landed at the solar module frame receiving side 808, the frame flange 803 of frame 802a can be moved into contact with biased engagement members 820a, 820b which can act, upon contact with the frame flange 803 of frame 802a, to move the biased engagement members 820a, 820b from the biased engagement position to the disengaged, retracted position. Then, when contact between the frame flange 803 of frame 802a and the biased engagement members 820a, 820b is removed via alignment of the two flange receiving apertures 831 of frame 802a, the bias force at the biased engagement members 820a, 820b can act to urge the biased engagement members 820a, 820b back to the biased engagement position to engage the solar module frame 802a and retain it at the torque tube 801. Likewise for coupling the frame 802b to the torque tube 801 using the same biased engagement members rail 804, as the frame flange 803 of frame 802b is landed at the solar module frame receiving side 808, the frame flange 803 of frame 802b can be moved into contact with biased engagement members 820c, 820d which can act, upon contact with the frame flange 803 of frame 802b, to move the biased engagement members 820c, 820d from the biased engagement position to the disengaged, retracted position. Then, when contact between the frame flange 803 of frame 802b and the biased engagement members 820c, 820d is removed via alignment of the two flange receiving apertures 831 of frame 802b, the bias force at the biased engagement members 820c, 820d can act to urge the biased engagement members 820c, 820c back to the biased engagement position to engage the solar module frame 802b and retain it at the torque tube 801 using the same biased engagement members rail 804 that engages the solar module frame 802a and retain it at the torque tube 801. This can then be repeated for other pairs for solar module frames along other portions of the torque tube 801. For instance, solar module frames 802 can be positioned relative to the torque tube 801 in an east-west orientation and a north-south orientation using the one or more biased engagement members 820 at the rail 804, e.g., such that the one or more biased engagement members 820 spring into place when an interfacing solar module 802 is positioned according to a predetermined east-west orientation relative to the torquer tube 801. This predetermined east-west orientation of the one or more solar module frames 802 relative to the torque tube 801 can correspond to the location of the one or more biased engagement members 820 along the length of the longitudinal side portion of the rail body 806.

FIG. 8F shows a flow diagram of an exemplary embodiment of method 890 for coupling one or more solar module frame(s) to a torque tube. In some example applications of the method 890, one or more features disclosed elsewhere herein can be utilized. As one such example, method 890 can couple one or more solar module frames to a torque tube using a biased engagement members rail, such as a biased engagement members rail having one or more (e.g., each) of the features disclosed elsewhere herein (e.g., one or more frame retention arms and one or more biased engagement members), and/or a solar module frame, such as a solar module frame with a frame flange and one or more flange receiving apertures.

At step 891, the method 890 includes installing a first biased engagement member rail at a torque tube. The first biased engagement member rail can be installed at the torque tube at step 891 with one or more biased engagement members of the first biased engagement member rail biased to an engagement position. As one example, the first biased engagement member rail can be installed at the torque tube by securing a fastening member (e.g., a U-bolt) between the first biased engagement member rail and the torque tube.

At step 892, the method 890 includes placing a first solar module frame at the first biased engagement member rail to transition the one or more biased engagement members of the first biased engagement member rail from the biased engagement position to a disengaged position. In certain embodiments, step 892 can occur after step 891. As one example, the one or more biased engagement members of the first biased engagement member rail can be transitioned from the biased engagement position to the disengaged position using a flange of the first solar module frame contacting the one or more biased engagement members of the first biased engagement member rail such that the flange contacting the one or more biased engagement members overcomes a bias force at the one or more biased engagement members to the engagement position to thereby cause the flange of the first solar module frame to urge the one or more biased engagement members to the disengagement position. This could include moving the first solar module frame relative to a solar module frame receiving side of the first biased engagement member rail to bring the flange at the first solar module frame into contact with the one or more biased engagement members (e.g., at a first longitudinal side portion of the solar module frame receiving side of the first biased engagement member rail) such that as the flange is moved over the one or more biased engagement members the flange pushes the one or more biased engagement members into the solar module frame receiving side of the first biased engagement member rail and away from the flange.

At step 893, the method 890 includes aligning one or more flange receiving apertures at the first solar module frame with the one or more biased engagement members of the first biased engagement member rail to transition the one or more biased engagement members of the first biased engagement member rail from the disengaged position to the biased engagement position. In certain embodiments, step 893 can occur after step 892. As one example, upon alignment between a flange receiving aperture at the first solar module frame (e.g., upon alignment between a flange receiving aperture at the flange of the first solar module frame) and a biased engagement member of the first biased engagement member rail, the bias force at the biased engagement member can cause the biased engagement member to move into the flange receiving aperture at the first solar module frame to secure the first solar module frame to the first biased engagement member rail. Thus, by axially aligning a flange receiving aperture at the flange of the first solar module frame with a biased engagement member, the contact between the flange and the biased engagement member can be removed allowing the bias force on the biased engagement member to push to biased engagement member back outward from the solar module frame receiving side of the first biased engagement member rail and toward the flange into the flange receiving aperture at the flange of the first solar module frame to the biased engagement position. With the biased engagement member moved back to its biased engagement position, the biased engagement member can engage the solar module frame at the flange receiving aperture and, thereby, act to apply one or more retention forces at the solar module frame to maintain the solar module frame at the first biased engagement member rail and, thus, at the torque tube.

In certain applications, the method 890 can further include placing a second solar module frame at the first biased engagement member rail adjacent to the first solar module frame (e.g., which is retained at the first biased engagement member rail as a result of step 893). In such applications, the method 890 can thus include: (i) placing the second solar module frame at the first biased engagement member rail to transition the one or more biased engagement members of the first biased engagement member rail from the biased engagement position to a disengaged position (e.g., at least two biased engagement members at a second longitudinal side portion of the solar module frame receiving side of the first biased engagement member rail), and (ii) aligning one or more flange receiving apertures at the second solar module frame with the one or more biased engagement members of the first biased engagement member rail (e.g., at the second longitudinal side portion of the solar module frame receiving side of the first biased engagement member rail) to transition the one or more biased engagement members of the first biased engagement member rail from the disengaged position to the biased engagement position. As such, a pair of solar module frames can be coupled to the torque tube using a single, common biased engagement member rail at the torque tube.

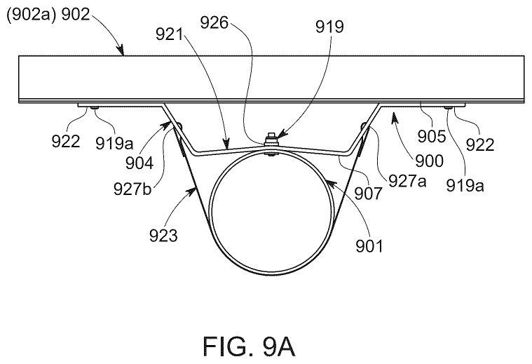

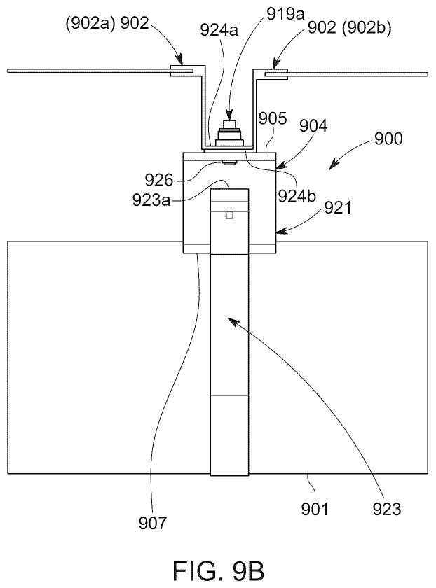

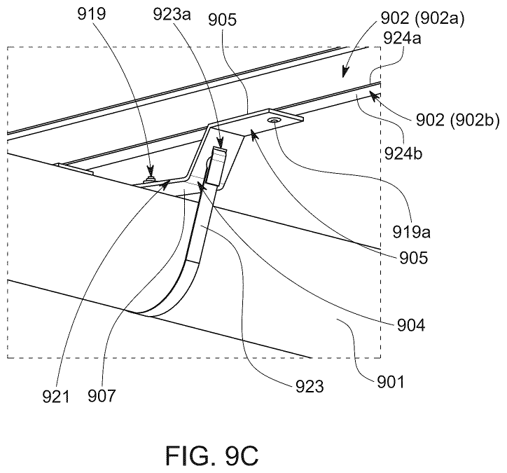

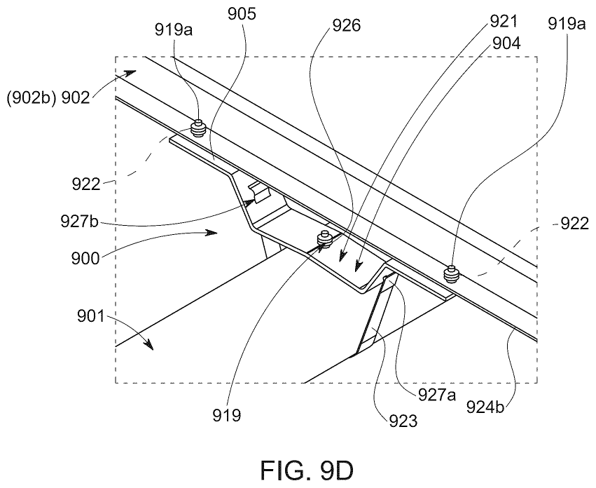

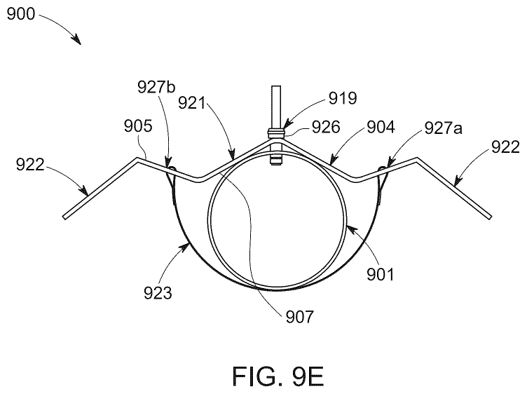

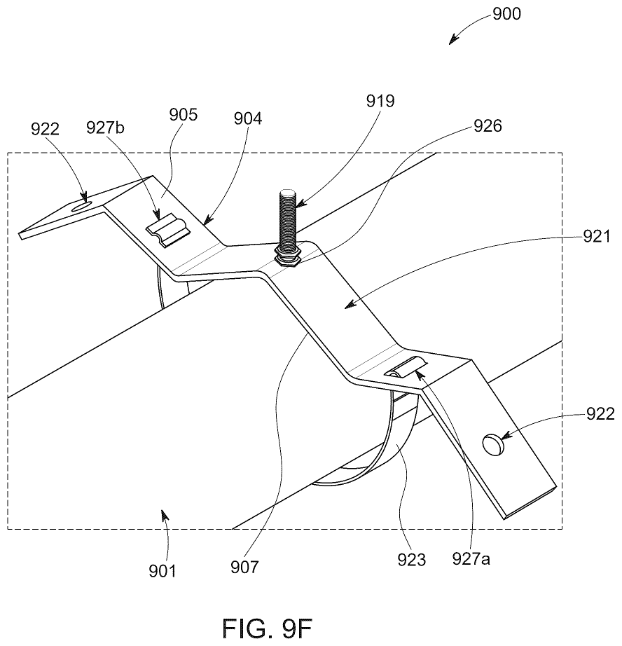

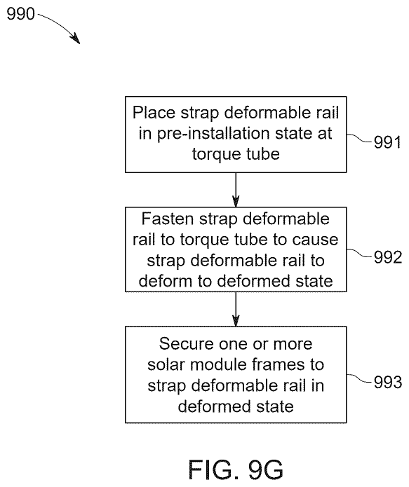

FIGS. 9A-9G illustrate an exemplary embodiment of a strap deformable rail solar module frame coupling apparatus 900. The strap deformable rail solar module frame coupling apparatus 900 can include one or more strap deformable rails 904 and one or more fastening members 919. The strap deformable rail solar module frame coupling apparatus 900 can be configured to receive one or more solar module frames 902 and couple such one or more solar module frames 902 to a torque tube 901. For example, the illustrated embodiment shows the strap deformable rail solar module frame coupling apparatus 900 configured to receive a pair of solar module frames 902a, 902b and couple the pair of solar module frames 902a, 902b to the torque tube 901. The one or more fastening members 919 can be any type of suitable fasteners. The illustrated embodiment shows a single fastening member 919 in the form of a blind rivet that is configured to couple the strap deformable rail 904 to the torque tube 901, though one or more fasteners 919 and any of a variety of suitable fasteners types can be used.

The strap deformable rail 904 can be configured to couple to both the torque tube 901 and to one or more solar module frames 902 received thereat such that the strap deformable rail 904 can act to couple such one or more solar module frames 902 to the torque tube 901. The illustrated embodiment shows the strap deformable rail 904 configured to receive a pair of solar module frames 902a, 902b and configured to couple this pair of solar module frames 902a, 902b to the torque tube 901.

The strap deformable rail 904 can be configured to deform between a pre-installation state and a deformed state. For example, the strap deformable rail 904 can be configured to deform from a pre-installation state and to a deformed state as a result of fastening the strap deformable rail 904 to the torque tube 901 using one or more fasteners 919 (e.g., as a result of fastening the strap deformable rail 904 to the torque tube 901 using a single blind rivet fastener 919). In this way, in some exemplary applications, the strap deformable rail 904 can be placed at the torque tube 901 in the pre-installation state, and then the strap deformable rail 904 can be deformed to the deformed state by driving fastener 919 into the strap deformable rail 904 and the torque tube 901. As one such example, the strap deformable rail 904 can be placed at the torque tube 901 by a temporary securement, such as a temporary securing engagement between the fastener 919 and each of a body of the strap deformable rail 904 that is in the pre-installation state and the torque tube 901 (e.g., a temporary securement where a tail of the fastener 919 engages the body of the strap deformable rail 904 and the torque tube 901 but a head of the fastener 919 is spaced apart from, and not in contact with, the body of the strap deformable rail 904). Then the strap deformable rail 904 can be deformed to the deformed state by driving fastener 919 into the strap deformable rail 904 and the torque tube 901 by further driving the temporarily secured fastener 919 into the strap deformable rail 904 and the torque tube 901 so as to bring a head of the fastener 919 into contact with a body of the strap deformable rail 904. In some embodiments, contact with the head of the fastener 919 can act to apply a deforming force at the body of the strap deformable rail 904 to cause the body of the strap deformable rail to deform from the pre-installation state to the deformed state. Accordingly, the strap deformable rail 904 can help to reduce a number of component parts and connection points and, as such, can be useful in facilitating installation and cost efficiencies associated with installing a solar tracking system on site.

The strap deformable rail 904 can include a rail body 921. The rail body 921 can be configured to deform between the pre-installation state and the deformed state. As such, the rail body 921 can be made of a deformable material that in some embodiments is elastically deformable between the pre-installation state and the deformed state or in other embodiments is inelastically deformable from the pre-installation state to the deformed state. As one example, the rail body 921 can be a sheet metal member, for instance, as shown here a single integral sheet metal piece.

The rail body 921 can have a frame receiving surface 905 and a torque tube interfacing surface 907 that can be opposite the frame receiving surface 905. The frame receiving surface 905 can be configured to receive one or more solar module frames 902, for instance, as shown here the frame receiving surface 905 can be configured to receive first and second solar module frames 902a, 902b. In particular, for the illustrated embodiment, the frame receiving surface 905 can be configured to receive both a radially extending frame flange 924a of first solar module frame 902a and a radially extending frame flange 924b of the second solar module frame 902b (e.g., with the radially extending flanges 924a, 924b overlapping, at least in part, at the frame receiving surface 905 such that one radially extending flange 924b can contact the frame receiving surface 905 and the other radially extending flange 924a can contact the radially extending flange 924b).

The rail body 921 can further can include one or more torque tube coupling apertures 926 and/or one or more solar module frame coupling apertures 922. The illustrated embodiment shows one torque tube coupling aperture 926, for instance at or near a central longitudinal region along a length of the rail body 921, and two frame coupling apertures 922, for instance at or near longitudinal ends along a length of the rail body 921. Thus, at the rail body 921, one frame coupling aperture 922 can be at one longitudinal side of the torque tube coupling aperture 926 and another frame coupling aperture 922 can be at another, opposite longitudinal side of the torque tube coupling aperture 926. Each of the torque tube coupling aperture 926 and frame coupling aperture(s) 922 can extend from the frame receiving surface 905 to the torque tube interfacing surface 907. The torque tube coupling aperture 926 can be configured to receive the fastener 919 (e.g., blind rivet) therethrough to temporarily secure and/or couple the rail body 921 to the torque tube 901. Each frame coupling aperture(s) 922 can be configured to receive a fastener 919a (e.g., blind rivet) therethrough to couple one or more solar module frames 902 to the rail body 921 (e.g., to couple a pair of radially extending flanges 924a 924b of a pair of solar module frames 902a, 902b to the rail body 921 is an overlapping orientation, such as shown at FIG. 9B).

In addition to the rail body 921, the strap deformable rail 904 can also include a strap 923. The strap 923 can be configured to extend from the rail body 921 and around the torque tube 901. The rail body 921 can include a first strap receptacle 927a and a second strap receptacle 927b, and the strap 923 can be secured to the rail body 921 at the first and second strap receptacles 927a, 927b. The first strap receptacle 927a can be at one longitudinal side of the torque tube coupling aperture 926 and the second strap receptacle 927b can be at another, opposite longitudinal side of the torque tube coupling aperture 926. For instance, the first strap receptacle 927a can be at one longitudinal side of the torque tube coupling aperture 926 between the torque tube coupling aperture 926 and the solar module frame coupling aperture 922 at that same longitudinal side, and the second strap receptacle 927a can be at another, opposite longitudinal side of the torque tube coupling aperture 926 between the torque tube coupling aperture 926 and the solar module frame coupling aperture 922 at that same, opposite longitudinal side. The strap 923 can have a first end portion that is secured at the first strap receptacle 927a and a second, opposite end portion that is secured at the second strap receptacle 927b. The strap 923 can be configured to extend from the first end portion at the first strap receptacle 927a, around the torque tube 901, and to the second end portion at the second strap receptacle 927b.

When the rail body 921 is in the pre-installation state, the strap 923 can be configured to have a reduced tension (e.g., no tension or minimal tension needed to keep strap deformable rail 904 temporarily secured at the torque tube 901 such as shown at FIGS. 9E and 9F), and then deforming the rail body 921 to the deformed state can cause tension in the strap 923 to increase such that when the rail body is in the deformed state the strap 923 can be configured to have increased tension in the strap 923 as compared to when the rail body 921 is in the pre-installation state. Thus, the strap 923 can have the same length extending out from the first and second strap receptacles 927a, 927b when the rail is in the pre-installation and deformed states, and causing the rail body 921 to deform from the pre-installation state to the deformed state can act to increase tension in the strap 923 and thereby act to increase the securement force between the rail body 921 and the torque tube 901. For instance, causing the rail body 921 to deform from the pre-installation state to the deformed state can act to impart an increased pulling/tension force on the strap 923 which in turn can act to increase the securement force between the rail body 921 and the torque tube 901, such as from no holding force pre-installation or a temporary pre-installation holding force to an installed solar tracker operational holding force.

FIGS. 9E-9F show the strap deformable rail 904 in an exemplary pre-installation state. In the pre-installation state, the rail body 921 of the strap deformable rail 904 can define a first shape in one or more planes, and in the pre-installation state the strap 923 can extend around the torque tube 901 and have a reduced tension force in the strap 923 (e.g., no tension or minimal tension needed to keep strap deformable rail 904 temporarily secured at the torque tube 901). For example, the illustrated embodiment of the rail body 921 in the pre-installation state shows the rail body 921 laying in multiple planes extending along a height of the rail body 921 such that the torque tube coupling aperture 926 lays in one elevational plane while one or more (e.g., two) frame coupling apertures 922 lay in lay in another, different elevational plane. In particular, the illustrated embodiment of the rail body 921 in the pre-installation state is shaped as a first shape having a repeating “V” cross-sectional shape that can from a type of wave-shape. For the illustrated embodiment of the rail body 921 in the pre-installation state, the central longitudinal portion of the rail body 921 having the torque tube coupling aperture 926 can be located in a plane higher than the two longitudinal end portions of the rail body 921 having the respective frame coupling apertures 921. For the illustrated example pre-installation state shown here, the torque tube coupling aperture 926 lays in one elevational plane that is above the torque tube 901 while the frame coupling apertures 922 at opposite longitudinal sides of the torque tube coupling aperture 926 lay in lower elevational plane than the torque tube coupling aperture 926 (e.g., the frame coupling apertures 922 at opposite longitudinal sides of the torque tube coupling aperture 926 lay in lower elevational plane that is below a highest elevation surface of the torque tube 901).

FIGS. 9A-9D show the strap deformable rail 904 in an exemplary deformed state. In the deformed state, the rail body 921 of the strap deformable rail 904 can define a second shape, in one or more planes, that is different than the first shape of the rail body 921 in the pre-installation state. And in the deformed state, the strap 923 can extend around the torque tube 901 and have an increased tension force in the strap 923 (e.g., a tension force in the strap 923 greater than any tension force in the strap 923 when the rail body 921 is in the pre-installation state). For example, the illustrated embodiment of the rail body 921 in the deformed state shows the rail body 921 laying in multiple planes extending along a height of the rail body 921 such that the torque tube coupling aperture 926 lays in one elevational plane while one or more (e.g., two) frame coupling apertures 922 lay in lay in another, different elevational plane. In particular, the illustrated embodiment of the rail body 921 in the deformed state is shaped as a second shape having a generally “U” cross-sectional shape with radially extending longitudinal end portion frame receiving surfaces at the top ends of the “U.” For the illustrated embodiment of the rail body 921 in the deformed state, the central longitudinal portion of the rail body 921 having the torque tube coupling aperture 926 can be located in a plane lower than, and closer to the torque tube 901, the two longitudinal end portions of the rail body 921 having the respective frame coupling apertures 921. For the illustrated example deformed state shown here, the torque tube coupling aperture 926 lays in one elevational plane that is above the torque tube 901 while the frame coupling apertures 922 at opposite longitudinal sides of the torque tube coupling aperture 926 lay in one or more higher elevational plane(s) (e.g., lay in a common higher elevational plane) than the torque tube coupling aperture 926 (e.g., the frame coupling apertures 922 at opposite longitudinal sides of the torque tube coupling aperture 926 lay in a higher elevational plane that is above a highest elevation surface of the torque tube 901 such that both the torque tube coupling aperture 926 and the frame coupling apertures 922 lay in different planes that are both above the highest elevation surface of the torque tube 901). Thus, in the deformed state, the central longitudinal region of the rail body 921 having the torque tube coupling aperture 926 can be closer to the torque tube 901 than the longitudinal end portions of the rail body 921 having the frame coupling apertures 922.

The strap deformable rail 904 can be transitioned from the pre-installation state (e.g., shown at FIGS. 9E-9F) to the deformed state (e.g., shown at FIGS. 9A-9D). The strap deformable rail 904 can be transitioned from the pre-installation state to the deformed state, for instance, after the strap deformable rail 904 has been both placed at the torque tube 901 and as a result of fastening the rail body 921 to the torque tube 901 such that the rail body 921 is caused to deform from the pre-installation state to the deformed state. For example, the strap deformable rail 904 can be configured to deform from the pre-installation state and to the deformed state as a result of fastening the strap deformable rail 904 to the torque tube 901 using the fastener 919 (using a single blind rivet fastener 919). In this way, the strap deformable rail 904 can be placed at the torque tube 901 in the pre-installation state, and then the strap deformable rail 904 can be deformed to the deformed state by driving fastener 919 into the rail body 921 and the torque tube 901.

As one such example, the strap deformable rail 904 can be placed at the torque tube 901 by a temporary securement where a tail of the fastener 919 is at both the torque tube coupling aperture 926 at the rail body 921 and at the torque tube 901 but a head of the fastener 919 is spaced apart from the torque tube 901 by a first distance. Then the strap deformable rail 904 can be deformed to the deformed state by driving the tail of the fastener 919 further into the torque tube coupling aperture 926 at the rail body 921 and further into the torque tube 901 so as to bring the head of the fastener 919 to a second distance from the torque tube 901 that is less than the first distance from the torque tube 901 in the pre-installation state. In some embodiments, further driving the fastener 919 into the rail body 921 to deform the rail body 921 from the pre-installation state to the deformed state can include contact between the head of the fastener 919 and the rail body 921 act to apply a deforming force via the head of the fastener 919 and/or via an increased tension force applied at the rail body 921 via the strap 923. The tension force applied by the strap 923 at the rail body 921 and/or the contact force applied by the head of the fastener 919 at the rail body 921 can act to thus deform the rail body 921 from the pre-installation state to the deformed state.

FIG. 9G is a flow diagram of an embodiment of a method 990 for coupling one or more solar module frame(s) to a torque tube using the exemplary embodiment of the strap deformable rail. In some example applications of the method 990, one or more features disclosed elsewhere herein can be utilized. As one such example, method 990 can couple one or more solar module frames to a torque tube using a strap deformable rail, such as a strap deformable rail having one or more (e.g., each) of the features disclosed elsewhere herein (e.g., a strap connected to a deformable rail body that is configured to deform from a pre-installation state to a deformed state as a result of driving a fastening member into the rail body (e.g., and further into the torque tube)). Similarly, in some examples the method 990 can couple one or more solar module frames to a torque tube using a strap deformable rail and one or more solar module frames disclosed elsewhere herein, such as a solar module frame with a radially extending frame flange and one or more flange receiving apertures.

At step 991, the method 990 includes placing a strap deformable rail in a pre-installation state at a torque tube. As one example, in the pre-installation state, the rail body of the strap deformable rail can define a first shape in one or more planes and the strap can extend around the torque tube with a relatively reduced tension force in the strap (e.g., no tension or minimal tension needed to keep strap deformable rail 904 temporarily secured at the torque tube 901). For example, the rail body placed at the torque tube in the pre-installation state at step 991 can lay in multiple planes extending along a height of the rail body such that the torque tube coupling aperture at the rail body lays in one elevational plane while one or more frame coupling apertures lay in lay in another, different elevational plane. One more specific such example of the rail body in the pre-installation state placed at step 991 can include the central longitudinal portion of the rail body having the torque tube coupling aperture located in a plane higher than the two longitudinal end portions of the rail body having the respective frame coupling apertures.

At step 992, the method 990 includes fastening the strap deformable rail to the torque tube to cause the strap deformable rail to deform to the deformed state. In examples disclosed herein, the rail body can be transitioned from the pre-installation state to the deformed state as a result of increasing tension in the strap by driving the fastening member (e.g., blind rivet) further into the rail body and torque tube. The increased tension in the strap resulting from further incremental driving of the fastening member into the rail body and the torque tube can act to apply a deforming tension force at the longitudinal end positions of the rail body which can cause the rail body to deform from the pre-installation state to the deformed state. In certain embodiments of the method 990, step 992 can occur after the strap deformable rail is placed in the pre-installation state at the torque tube at step 991. As one example, in the rail body deformed state induced at step 992, the rail body of the strap deformable rail can define a second shape in one or more planes that is different than the first shape of the rail body in the pre-installation state, and in the rail body deformed state induced at step 992 the strap can extend around the torque tube having an increased tension force in the strap that is greater than any tension force in the strap when the rail body is in the pre-installation state. For example, in the deformed state induced at step 992, the rail body can lay in multiple planes extending along a height of the rail body such that the torque tube coupling aperture lays in one elevational plane while the frame coupling aperture(s) lay in lay in another, different elevational plane. For instance, the rail body 921 induced into the deformed state, the central longitudinal portion of the rail body with the torque tube coupling aperture 926 can be located in a plane lower than, and closer to the torque tube, than the two longitudinal end portions of the rail body having the respective frame coupling apertures. Thus, in the deformed state, the central longitudinal region of the rail body 921 having the torque tube coupling aperture 926 can be closer to the torque tube 901 than the longitudinal end portions of the rail body 921 having the frame coupling apertures 922.

At step 993, the method 990 includes securing one or more solar module frames to the strap deformable rail that is in the deformed state. In certain embodiments of the method 990, step 993 can occur after the strap deformable rail is deformed to the deformed state at step 992. As one example, at step 993, the method 990 can include placing a radially extending flange of a first solar module frame at a frame receiving surface of the rail body that is in the deformed state. This first solar module can then be secured to the rail body at the frame receiving surface of the rail body by driving one or more fasteners through the overlaid radially extending flange of the first solar module frame and the frame receiving surface of the rail body.

In certain applications, at step 993 the method 990 can further include placing first and second solar module frames at the strap deformable rail that is in the deformed state. In such applications, the method 990 can thus include placing a radially extending frame flange of a first solar module frame at a frame receiving surface of the rail body that is in the deformed state and placing a radially extending frame flange of a second solar module frame at the frame receiving surface of the rail body that is in the deformed state. As one such example, the radially extending frame flange of the second solar module frame can overlay, such as in a stacked arrangement, the radially extending frame flange of the first solar module frame at the frame receiving surface of the rail body that is in the deformed state. In a further such example, a fastening member can be inserted through each of the first and second radially extending frame flanges to couple the pair of solar module frames to the torque tube using the strap deformed rail in the deformed state.

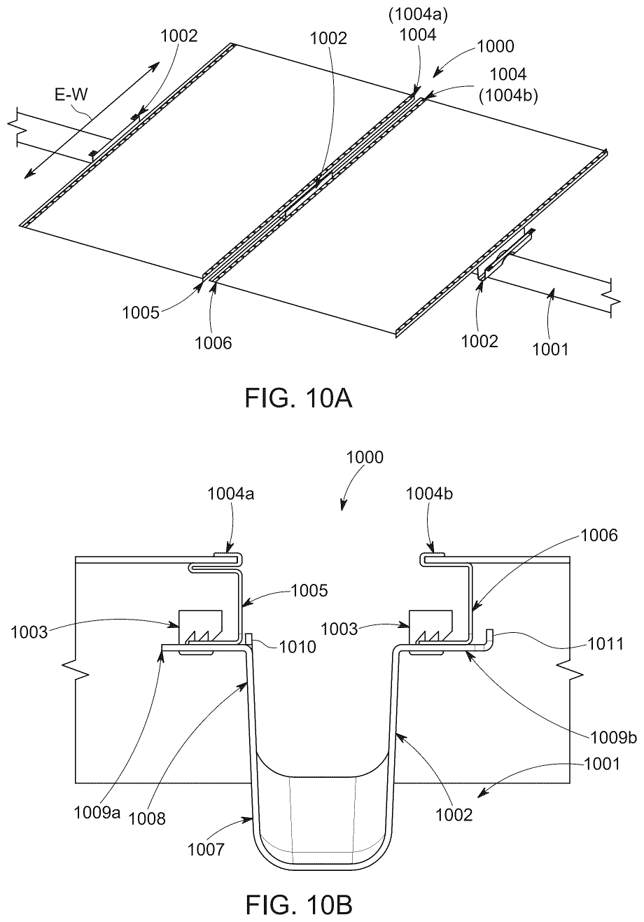

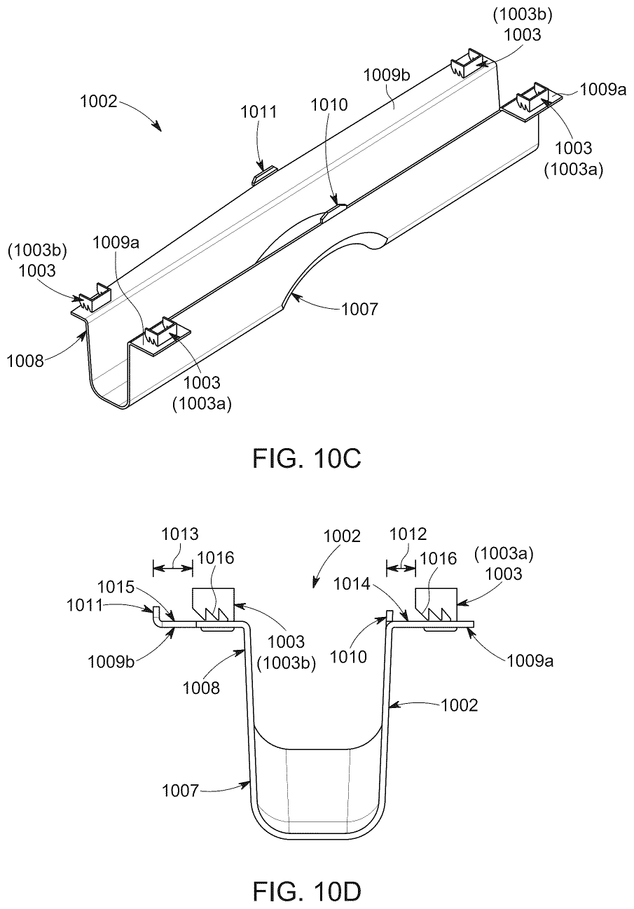

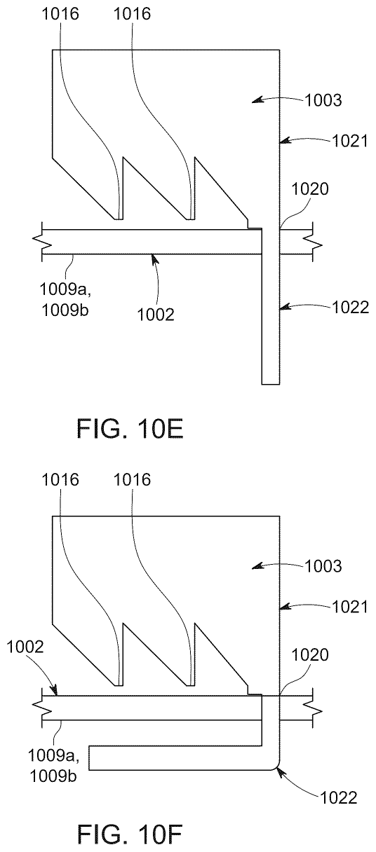

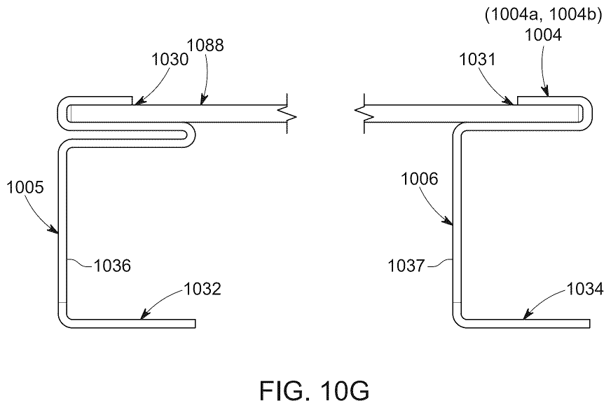

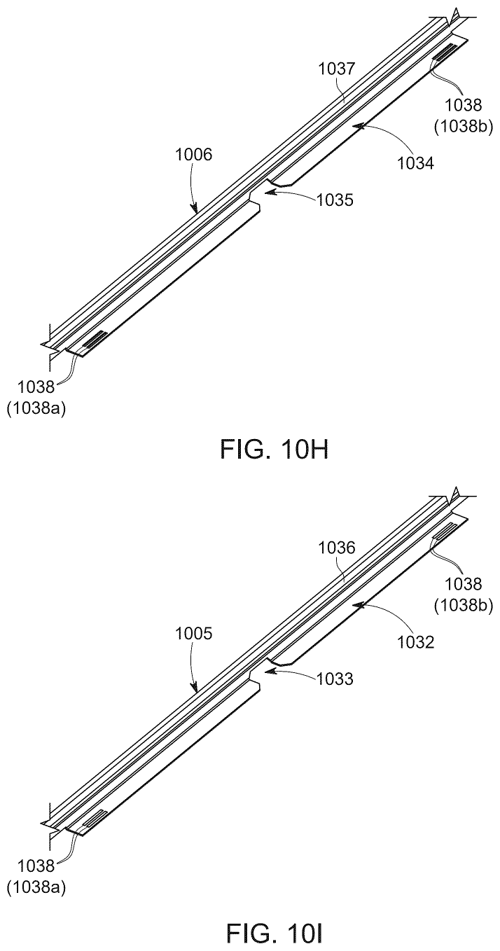

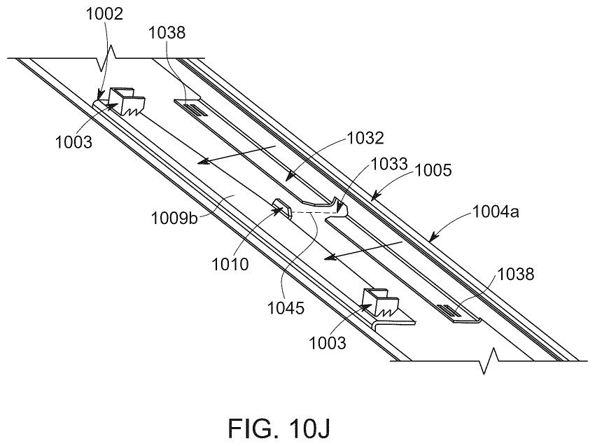

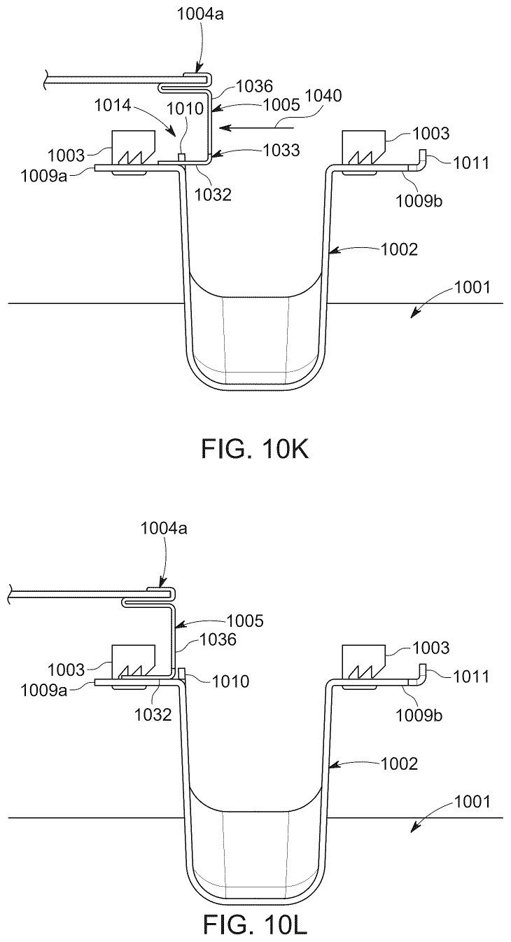

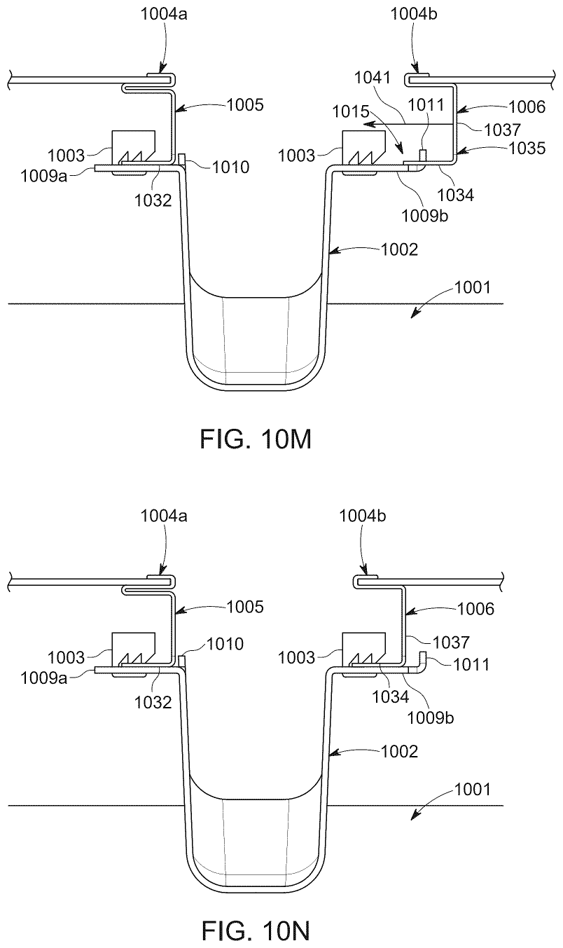

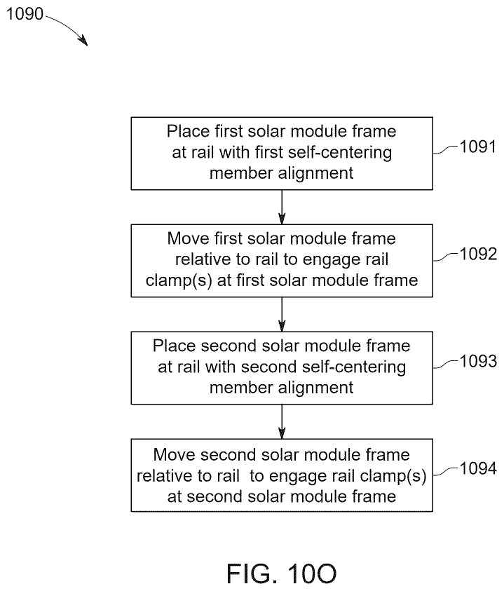

FIGS. 10A-10O illustrate an exemplary embodiment of self-centering rail system 1000 as well as components of this self-centering rail system 1000 and a method for installing solar module frames, for instance, using the self-centering rail system 1000. The self-centering rail system 1000 can be useful for coupling solar module frames 1004 to a torque tube 1001 of a solar tracker, such as the solar tracker illustrated at FIG. 1. For instance, the self-centering rail system 1000 can be configured to couple a pair of solar module frames to a torque tube of a solar tracker using a self-centering rail to couple the pair of solar module frames to the torque tube. The self-centering rail system 1000 can facilitate more labor and cost efficient installation of solar module frames at a solar tracker by helping to reduce a number of component connections and fastening points in solar module frame installation while providing a structurally stable coupling arrangement for prolonged service life in the field.

FIG. 10A is a perspective view of the self-centering rail system 1000 and FIG. 10B is a side elevational view of the self-centering rail system 1000. The self-centering rail system 1000 can include one or more self-centering rails 1002 and one or more solar module frames 1004. The one or more self-centering rails 1002 can each have a bottom portion 1007 that is configured to interface with the torque tube 1001 of the solar tracker and an opposite top portion 1008 that is configured to interface with one or more solar module frames 1004. For example, the bottom portion 1007 of the self-centering rail 1002 can include a cross-sectional geometry (e.g., semi-circular) that matches a corresponding cross-sectional geometry of the torque tube 1001. The top portion 1008 of the self-centering rail 1002 can include at least one first frame support arm 1009a at a first side of the top portion 1008 and at least one second frame support arm 1009b at a second, opposite side of the top portion 1008. The at least one first frame support arm 1009a at the first side of the top portion 1008 of the self-centering rail 1002 can be configured to receive and support one solar module frame 1004a thereat, and the at least one second frame support arm 1009b at the second, opposite side of the top portion 1008 of the self-centering rail 1002 can be configured to receive and support another solar module frame 1004b thereat. A plurality of self-centering rails 1002 can be placed along a longitudinal length of the torque tube 1001, such as shown at FIG. 10A, and used to couple pairs of solar module frames 1004 to the torque tube 1001 thereat. The self-centering rails 1002 can be fastened to the torque tube 1001 to secure each self-centering rail 1002 at the torque tube 1001.

As will be described further herein, the self-centering rail 1002 and the one or more solar module frames 1004 (e.g., 1004a, 1004b) can include one or more features configured to help self-center each self-centering rail 1002 relative to the torque tube 1001 in an east-west orientation, such as shown at FIG. 10A. In addition, the self-centering rail 1002 and the one or more solar module frames 1004 (e.g., 1004a, 1004b) can include one or more features configured to help provide a structurally stable coupling arrangement of the solar module frames 1004 at the torque tube 1001 for prolonged service life.

FIGS. 10C and 10D show the self-centering rail 1002 in isolation. Specifically, FIG. 10C is a perspective view of the self-centering rail 1002 and FIG. 10D is a side elevational view of the self-centering rail 1002. The self-centering rail 1002 is shown here as a generally U-shaped member that is configured to sit on, and be secured to, the torque tube 1001.

The self-centering rail 1002 can include one or more rail clamps 1003. The one or more rail clamps 1003 can be configured to engage solar module frame 1004 to thereby help retain solar module frame 1004 at the self-centering rail 1002. The self-centering rail can include one or more rail clamps 1003 at one side portion (e.g., at one side of the top portion 1008) and one or more rail clamps 1003 at another, opposite side portion (e.g., at another, opposite side of the top portion 1008). The illustrated embodiment includes two rail clamps 1003 at one side of the top portion 1008 of the self-centering rail 1002 and two rail clamps 1003 at another, opposite side of the top portion 1008 of the self-centering rail 1002. In particular, the illustrated embodiment of the self-centering rail 1002 includes one or more rail clamps 1003 (e.g., at least two rail clamps 1003) at the first frame support arm 1009a at one side of the top portion 1008 and includes one or more rail clamps 1003 (e.g., at least two rail clamps 1003) at the second frame support arm 1009b at the opposite side of the top portion 1008. The rail clamps 1003 can include a plurality of teeth members 1016 that face and project towards the respective frame support arm 1009a, 1009b. A space can be defined between a projecting end of each tooth 1016 and the respective frame support arm 1009a, 1009b to receive at such space a portion (e.g., flange portion) of the respective solar module frame 1004a, 1004b. The teeth members 106 at each rail clamp 1003 can be configured to provide a retention force at the received portion (e.g., flange portion) of the respective solar module frame 1004a, 1004b.

The self-centering rail 1002 can also include one or more rail self-centering members 1010, 1011. For example, the self-centering rail 102 can include first rail self-centering member 1010 at one side of top portion 1008 and include second rail self-centering member 1011 at another, opposite side of top portion 1008. For the illustrated example, the first rail self-centering member 1010 is shown as a tab member that projects outward from the from the top portion 1008 of the self-centering rail 1002 to terminate at an elevation along the self-centering rail 1002 above an elevation of the first frame support arm 1009a. Though other embodiments can include other various forms of a projecting self-centering member. Also for the illustrated example, the second rail self-centering member 1011 is shown as a tab member that projects outward from the from the top portion 1008 of the self-centering rail 1002 to terminate at an elevation along the self-centering rail 1002 above an elevation of the second frame support arm 1009b. Though other embodiments can include other various forms of a projecting self-centering member.

As illustrated, the first self-centering member 1010 at a first side of the top portion 1008 can be spaced longitudinally along the self-centering rail 1002 from the rail clamps 1003a at the same first side of the top portion 1008 as well as spaced radially a radial distance 1012 along the self-centering rail 1002 from the rail clamps 1003a at the same first side of the top portion 1008. The radial distance 1012 between rail clamps 1003a and first self-centering member 1010 can define first solar module frame landing surface 1014 between the rail clamps 1003a and first self-centering member 1010 (e.g., for landing a portion of first solar module frame 1004a, such as for landing the first side portion 1005 of the first solar module frame 1004a prior to engaging the first side portion 1005 of the first solar module frame 1004a with the rail clamps 1003a). Likewise, as also illustrated, the second self-centering member 1011—e.g., at a second, opposite side of the top portion 1008 from the first self-centering member 1010—can be spaced longitudinally along the self-centering rail 1002 from the rail clamps 1003b at the same second side of the top portion 1008 as well as spaced radially a radial distance 1013 along the self-centering rail 1002 from the rail clamps 1003b at the same second side of the top portion 1008. The radial distance 1013 between rail clamps 1003b and second self-centering member 1011 can define second solar module frame landing surface 1015 between rail clamps 1003b and second self-centering member 1011 (e.g., for landing a portion of second solar module frame 1004b, such as for landing the second side portion 1006 of the second solar module frame 1004b prior to engaging the second side portion 1006 of the second solar module frame 1004b with the rail clamps 1003b).

The first and second self-centering members 1010, 1011 at the self-centering rail 1002 (e.g., in combination with complementary self-centering members at the respective portion of the received solar module frame 1004a, 1004b) can be configured to help self-center each self-centering rail 1002 relative to the torque tube 1001 in an east-west orientation during installation of the self-centering rail 1002 and solar module frames 1004a, 1004b at the self-centering rail 1002. For example, the first self-centering member 1010, along with a complementary frame self-centering member at the first frame 1004a (e.g., the first side portion 1005 of the first frame 1004a), and the second self-centering member 1011, along with a complementary frame self-centering member at the second frame 1004b (e.g., the second side portion 1006 of the second frame 1004b), can be configured to help self-center the self-centering rail 1002 relative to the torque tube 1001 in an east-west orientation during installation.

FIGS. 10E and 10F illustrate installation of one exemplary rail clamp 1003 at the self-centering rail 1002. Specifically, FIG. 10E is a side elevational view of either frame support arm 1009a or 1009b of self-centering rail 1002 with rail clamp 1003 prior to installation at the self-centering rail 1002, and FIG. 10F is a side elevational view of the rail clamp 1003 installed at either frame support arm 1009a or 1009b of the self-centering rail 1002.

As shown for the example illustrated here, the rail clamp 1003 can include a main rail clamp body 1021 and a rail clamp tail 1022 that extends out from the main rail clamp body 1021. As shown at FIG. 10E, before the rail clamp 1003 is installed at the self-centering rail 1002, the rail clamp tail 1022 can extends out from the main rail clamp body 1021 at a first, pre-installation orientation. The example at FIG. 10E shows this first pre-installation orientation of the rail clamp tail 1022 as linear and laying in a single plane. To install the rail clamp 1003 at a frame support arm (e.g., 1009a and/or 1009b) at the self-centering rail 1002, the rail clamp tail 1022 in the first preinstallation orientation can be passed through a clamp receiving aperture 1020 at the frame support arm at the self-centering rail 1002, for instance, as shown at FIG. 10E. Then, once the rail clamp tail 1022 in the first preinstallation orientation is passed through the clamp receiving aperture 1020, the rail clamp tail 1022 can be deformed to a second, installation orientation, such as shown at FIG. 10F, which can be different than the first, preinstallation orientation. The example at FIG. 10F shows this installation orientation of the rail clamp tail 1022 as non-linear and laying in multiple planes. For instance, once the rail clamp tail 1022 has been passed through the clamp receiving aperture 1020, the rail clamp tail 1022 can be bent from the first preinstallation orientation into the second installation orientation that includes the rail clamp tail 1022 extending though the clamp receiving aperture 1020 at the frame support arm (e.g., 1009a and/or 1009b) and wrapping around to an opposite bottom portion of the frame support arm (e.g., 1009a and/or 1009b). As noted previously herein, the rail clamp 1003 can be installed at the self-centering rail 1002 such that a space is defined between the teeth 1016 at the rail clamp main body 1021 and the frame support arm (e.g., 1009a and/or 1009b) such that a portion (e.g., flange portion) of a respective solar module frame 1004a or 1004b can be received at this space therebetween.

FIGS. 10G-10I illustrate an embodiment of solar module frame 1004, for instance, which can be used in the self-centering rail system 1000. FIG. 10G is a side elevational view of solar module frame 1004, FIG. 10H is a perspective view of first side portion 1005 of solar module frame 1004, and FIG. 10I is a perspective view of second, opposite side portion 1006 of solar module frame 1004. The solar module frame 1004 can be configured to receive and retain a plurality of photovoltaic cells 1088 thereat. For instance, the plurality of photovoltaic cells 1088 can be included at a cell substrate, such as a laminate, and the solar module frame 1004 can be configured to hold and retain the cell substrate thereat.

As noted previously herein, the solar module frame 1004 can include first side portion 1005 and opposite second side portion 1006. The first side portion 1005 can include a first photovoltaic retention slot 1030 and the second side portion 1006 can include a second photovoltaic retention slot 1031. A cell substrate having a plurality of photovoltaic cells 1088 can thus be held at and retained between the first photovoltaic retention slot 1030 at the first side portion 1005 and the second photovoltaic retention slot 1031 at the second side portion 1006.

The first side portion 1005, shown for example FIG. 10I, can include a first side flange 1032. The first side flange 1032 can extend out from a first side vertical wall 1036. As shown here, the first side flange 1032 can extend out from the first side vertical wall 1036 in a direction toward the second side portion 1006 of the frame 1004. The first side flange 1032 can be configured to be received at the self-centering rail 1002. For example, the first side flange 1032 can be configured to be received at the first landing surface 1014 at the self-centering rail 1002. Then the first side flange 1032 can be moved toward the one or more rail clamps 1003 (e.g., the pair of rail clamps 1003 interfacing with the first side portion 1005 when the frame 1004 is landed at the self-centering rail 1002) to cause the rail clamps 1003 to engage the first side flange 1032.

The first side portion 1005 of the frame 1004 can also include a first side frame self-centering member 1033. The first side portion 1005 can include the first side frame self-centering member 1033 at least at the first side flange 1032, and the first side portion 1005 can include the retention slots 1038 also at least at the first side flange 1032. The first side frame self-centering member 1033 can be complementary to the first rail self-centering member 1010 such that engagement between the first side frame self-centering member 1033 and the first rail self-centering member 1010 can act to provide east-west orientation alignment between a solar module frame received thereat and the self-centering rail 1002. The illustrated embodiment shows the first side frame self-centering member 1033 formed as a notch opening defined at the first side flange 1032 complementary to, for receiving, the tab example shown previously for the first rail self-centering member 1010. Though in other embodiments the first side frame self-centering member 1033 can take other forms within the scope of this disclosure.

In addition to the first side flange 1032 and/or first side frame self-centering member 1033, the first side portion 1005 can further include one or more retention slots 1038. The retention slots 1038 can be configured to engage with a rail clamp to thereby help retain the solar module frame 1004 at the self-centering rail 1002. The illustrated embodiment shows the retention slots 1038 defined at the first side flange 1032, and the retention slots 1038 can extend through the first side flange 1032. For example, the illustrated embodiment of the first side portion 1005 can be configured to engage with two rail clamps that are at a same side of the self-centering rail 1002. As such, the illustrated embodiment includes a first set of two or more retention slots 1038a at one longitudinal location along the first side flange 1032 to engage with one such rail clamp at the self-centering rail side and a second set of two or more retention slots 1038b at another, different longitudinal location along the first side flange 1032 spaced apart from the first set of retention slots 1038a to engage with another such rail clamp at the self-centering rail side. The retention slots 1038 can be configured to engage with the teeth members 1016 at the rail clamp 1003 such that the teeth members 1016 can extend within the retention slots 1038 when the first side flange 1032 is coupled to the side of the self-centering rail.

The second side portion 1006, shown for example at FIG. 10H, can include a second side flange 1034. The second side flange 1034 can extend out from a second side vertical wall 1037. As shown here, the second side flange 1034 can extend out from the second side vertical wall 1037 in a direction toward the first side portion 1005 of the frame 1004. The second side flange 1034 can be configured to be received at the self-centering rail 1002 (e.g., second side flange 1034 of solar module frame 1004b can be received at an opposite side of the self-centering rail 1002 as first side flange 1032 of another solar module frame 1004a). For example, the second side flange 1034 can be configured to be received at the second landing surface 1015 at the self-centering rail 1002. Then the second side flange 1034 can be moved toward the one or more rail clamps 1003 (e.g., the pair of rail clamps 1003 interfacing with the second side portion 1006 when the frame 1004 is landed at the self-centering rail 1002) to cause the rail clamps 1003 to engage the second side flange 1034.

The second side portion 1006 of the frame 1004 can also include a second side frame self-centering member 1035. The second side portion 1006 can include the second side frame self-centering member 1035 at least at the second side flange 1034, and the second side portion 1006 can include retention slots 1038 also at least at the second side flange 1034. The second side frame self-centering member 1035 can be complementary to the second rail self-centering member 1011 such that engagement between the second side frame self-centering member 1035 and the second rail self-centering member 1011 can act to provide east-west orientation alignment between a solar module frame received thereat and the self-centering rail 1002. The illustrated embodiment shows the second side frame self-centering member 1035 formed as a notch opening defined at the second side flange 1034 complementary to, for receiving, the tab example shown previously for the second rail self-centering member 1011. Though in other embodiments the second side frame self-centering member 1035 can take other forms within the scope of this disclosure.

In addition to the second side flange 1034 and/or second side frame self-centering member 1035, the second side portion 1006 can further include one or more retention slots 1038. The retention slots 1038 can be configured to engage with a rail clamp to thereby help retain the solar module frame 1004 at the self-centering rail 1002. The illustrated embodiment shows the retention slots 1038 defined at the second side flange 1034, and the retention slots 1038 can extend through the second side flange 1032. For example, the illustrated embodiment of the second side portion 1006 can be configured to engage with two rail clamps that are at a same side of the self-centering rail 1002 but at an opposite side of the self-centering rail 1002 from where the first side portion 1005 engages the self-centering rail 1002. As such, the illustrated embodiment includes a first set of two or more retention slots 1038a at one longitudinal location along the second side flange 1034 to engage with one such rail clamp at the self-centering rail side and a second set of two or more retention slots 1038b at another, different longitudinal location along the second side flange 1034 spaced apart from the first set of retention slots 1038a to engage with another such rail clamp at the self-centering rail side. The retention slots 1038 can be configured to engage with the teeth members 1016 at the rail clamp 1003 such that the teeth members 1016 can extend within the retention slots 1038 when the second side flange 1034 is coupled to the side of the self-centering rail.

FIGS. 10J-10N illustrate an exemplary sequence for coupling first and second solar module frames 1004a, 1004b to a torque tube 1001 of a solar tracker using the self-centering rail system 1000. And FIG. 10O is a flow diagram of an embodiment of a method 1090 for coupling first solar module frame 1004a and second solar module frame 1004b to self-centering rail 1002. For instance, the method 1090 can, in some examples, be executed to couple the first solar module frame 1004a and the second solar module frame 1004b to the torque tube 1001 of a solar tracker using the self-centering rail system 1000 using one or more portions (e.g., each of the portions) of the sequence illustrated at FIGS. 10J-10N. As such, the sequence shown at FIGS. 10J-10N will be described in reference to the method 1090 of FIG. 10O as follows.

At step 1091, the method 1090 includes placing a first solar module frame at a self-centering rail with first self-centering member alignment. For example, as shown at FIG. 10J, step 1091 can include placing first solar module frame 1004a at self-centering rail 1002 with first frame self-centering member 1033 at first module frame 1004a aligned with first rail self-centering member 1010 at a first side of the self-centering rail 1002. As seen at FIG. 10J, this can include axial alignment along axis 1045 between the complementary first frame self-centering member 1033 and first rail self-centering member 1010 at the first side of the self-centering rail 1002. More specifically, step 1091 can include placing first side portion 1005 flange 1032 to interface with the first side of the self-centering rail 1002 with axial alignment along axis 1045 between the complementary first frame self-centering member 1033 and first rail self-centering member 1010 at the first side of the self-centering rail 1002.

At step 1092, the method 1090 includes moving the first solar module frame relative to the rail to engage one or more rail clamps that are at the self-centering rail to the first solar module frame. For example, as shown at FIGS. 10K and 10L, step 1092 can include moving first solar module frame 1004a, in direction 1040, to engage one or more rail clamps 1003 (e.g., two or more rail clamps 1003) that are at the self-centering rail 1002 to the first solar module frame 1004a. As illustrated here, step 1092 can include sliding first side flange 1032 of first solar module frame 1004a relative to rail self-centering member 1010 and relative to first frame landing surface 1014 at self-centering rail 1002. The first side flange 1032 of first solar module frame 1004a can be slid relative to rail self-centering member 1010 and relative to first frame landing surface 1014 at self-centering rail 1002 to cause the rail self-centering member 1010 to intersect the first side frame self-centering member 1033 that is defined at the first side flange 1032 at the frame 1004a. In one such example as seen at FIGS. 10K and 10L, the first side flange 1032 can be slid relative to rail self-centering member 1010 and relative to first frame landing surface 1014 at self-centering rail 1002 to cause the rail self-centering member 1010 to pass through the first side frame self-centering member 1033 (e.g., pass through a notch forming first side frame self-centering member 1033) such that the rail self-centering member 1010 moves from one side of vertical wall 1036, though the first side frame self-centering member 1033, and to another opposite side of vertical wall 1036 to engage one or more rail clamps 1003 at self-centering rail 1002. For instance, as the first side flange 1032 is slid relative to the self-centering rail 1002, the rail self-centering member 1010 can move from one side of vertical wall 1036, though the first side frame self-centering member 1033 by passing through the notch thereat, and to another opposite side of vertical wall 1036 to engage one rail clamp 1003 at one set of retention slots 1038 at the first side flange 1032 and to engage another rail clamp 1003 to another set of retention slots 1038 at the first side flange 1032.

At step 1093, the method 1090 includes placing a second solar module frame at the self-centering rail with second self-centering member alignment. For example, the second solar module frame can be so placed at step 1093 such that the second solar module frame is placed at the same self-centering rail at which the first solar module frame was placed at step 1091. For instance, the first solar module frame can be placed at step 1091 and moved at step 1092 relative to a first side of the self-centering rail while the second solar module frame can be placed at step 1093 (and moved at step 1094) relative to a second, opposite side of the self-centering rail. For example, as shown at FIG. 10M, step 1093 can include placing second solar module frame 1004b at self-centering rail 1002 with second side frame self-centering member 1035 at second module frame 1004b aligned with second rail self-centering member 1011 at a second side of the self-centering rail 1002 (e.g., where the second side of the self-centering rail 1002 at which the second solar moule frame 1004b is placed is opposite the first side of the self-centering rail 1002 at which the first solar module frame 1004a is placed). This can include axial alignment along an axis extending between the complementary second side frame self-centering member 1035 and second rail self-centering member 1011 at the second side of the self-centering rail 1002. More specifically, step 1093 can include placing second side portion 1006 flange 1034 to interface with the second side of the self-centering rail 1002 with axial alignment along the axis extending between the complementary second frame self-centering member 1035 and second rail self-centering member 1011 at the second side of the self-centering rail 1002.

At step 1094, the method 1090 includes moving the second solar module frame relative to the rail to engage one or more rail clamps at the rail to the second solar module frame. For example, as shown at FIGS. 10M and 10N, step 1094 can include moving second solar module frame 1004b, in direction 1041 (e.g., opposite direction 1040), to engage one or more rail clamps 1003 (e.g., two or more rail clamps 1003) that are at the self-centering rail 1002 to the second solar module frame 1004b. As illustrated here, step 1094 can include sliding second side flange 1034 of second solar module frame 1004b relative to rail self-centering member 1011 and relative to second frame landing surface 1015 at self-centering rail 1002. The second side flange 1034 can be slid relative to rail self-centering member 1011 and relative to second frame landing surface 1015 to cause the rail self-centering member 1011 to intersect the second side frame self-centering member 1035 that is defined at the second side flange 1034 at the second frame 1004b. In one such example as seen at FIGS. 10M and 10N, the second side flange 1034 can be slid relative to rail self-centering member 1011 and relative to second frame landing surface 1015 to cause the rail self-centering member 1011 to pass through the second side frame self-centering member 1035 (e.g., pass through a notch forming second side frame self-centering member 1035) such that the rail self-centering member 1011 moves from one side of vertical wall 1037, though the second side frame self-centering member 1035, and to another opposite side of vertical wall 1037 to engage one or more rail clamps 1003 at self-centering rail 1002. For instance, as the second side flange 1034 is slid relative to the self-centering rail 1002, the rail self-centering member 1011 can move from one side of vertical wall 1037, though the second side frame self-centering member 1035 by passing through the notch thereat, and to another opposite side of vertical wall 1037 to engage one rail clamp 1003 at one set of retention slots 1038 at the second side flange 1034 and to engage another rail clamp 1003 to another set of retention slots 1038 at the second side flange 1034.

Various examples have been described. These and other examples are within the scope of the following claims.

What is claimed is:

1. A self-centering rail system comprising:
a first solar module frame comprising a first flange and a first frame self-centering member included at least at the first flange;
a second solar module frame comprising a second flange and a second frame self-centering member included at least at the second flange; and
a self-centering rail comprising:
a first side portion comprising a first frame support arm, a first rail clamp, a second rail clamp, and a first rail self-centering member, wherein each of the first rail clamp, the second rail clamp, and the first rail self-centering member is at the first frame support arm;
a second side portion comprising a second frame support arm, a third rail clamp, a fourth rail clamp, and a second rail self-centering member, wherein each of the third rail clamp, the fourth rail clamp, and the second rail self-centering member is at the second frame support arm,
wherein the first side portion is configured to couple to the first solar module frame when the first flange is received at the first rail clamp and the second rail clamp and when the first frame self-centering member is received at the first rail self-centering member, and
wherein the second side portion is configured to couple to the second solar module frame when the second flange is received at the third rail clamp and the fourth rail clamp and when the second frame self-centering member is received at the second rail self-centering member.

2. The system of claim 1, wherein the first solar module frame comprises a first set of retention slots spaced from a first side of the first frame self-centering member at the first flange, and wherein the first solar module frame comprises a second set of retention slots spaced from a second, opposite side of the first frame self-centering member at the first flange.

3. The system of claim 2, wherein the first rail clamp is spaced from a first side of the first rail self-centering member at the first frame support arm, and wherein the second rail clamp is spaced from a second, opposite side of the first rail self-centering member at the first frame support arm.

4. The system of claim 3, wherein the first rail clamp, the second rail clamp, and the first rail self-centering member extend out from a top side of the first frame support arm.

5. The system of claim 4, wherein the self-centering rail comprises a bottom side that is opposite the top side of the first frame support arm, and wherein the bottom side of the self-centering rail comprises a generally semi-circular cross-sectional geometry configured to receive a torque tube.

6. The system of claim 4, wherein each of the first rail clamp and the second rail clamp comprise teeth members, and wherein each of the first set of retention slots and the second set of retention slots comprises slots extending through the first flange.

7. The system of claim 6, wherein the teeth members of the first rail clamp engage the slots of the first set of retention slots extending through the first flange when the first flange is received at the first rail clamp and the second rail clamp and when the first frame self-centering member is received at the first rail self-centering member.

8. The system of claim 7, wherein the first frame self-centering member comprises a slot extending into the first flange, and wherein, as the first rail self-centering member is received at the slot extending into the first flange, the first rail self-centering member is configured to adjust a position of the first solar module frame relative to a torque tube in an east-west direction.

9. The system of claim 7, wherein the first rail clamp is radially spaced apart from the first rail self-centering member to define a landing surface radially between the first rail clamp and the first rail-self centering member.

10. The system of claim 9, wherein the first frame support arm terminates at a first floating end that defines an outside bound of the first side portion, and wherein the first rail-self centering member is closer to the first floating end than is the first rail clamp.

11. A self-centering rail comprising:
a first side portion comprising a first frame support arm, a first rail clamp, a second rail clamp, and a first rail self-centering member, wherein each of the first rail clamp, the second rail clamp, and the first rail self-centering member is at the first frame support arm; and
a second side portion comprising a second frame support arm, a third rail clamp, a fourth rail clamp, and a second rail self-centering member, wherein each of the third rail clamp, the fourth rail clamp, and the second rail self-centering member is at the second frame support arm,
wherein the first side portion is configured to couple to a first solar module frame when a first flange of the first solar module frame is received at the first rail clamp and the second rail clamp and when a frame self-centering member of the first solar module frame is received at the first rail self-centering member, and
wherein the second side portion is configured to couple to a second solar module frame when a second flange of the second solar module frame is received at the third rail clamp and the fourth rail clamp and when a frame self-centering member of the second solar module frame is received at the second rail self-centering member.

12. The rail of claim 11,
wherein the first rail clamp is spaced from a first side of the first rail self-centering member at the first frame support arm, and wherein the second rail clamp is spaced from a second, opposite side of the first rail self-centering member at the first frame support arm, and
wherein the third rail clamp is spaced from a first side of the second rail self-centering member at the second frame support arm, and wherein the fourth rail clamp is spaced from a second, opposite side of the second rail self-centering member at the second frame support arm.

13. The rail of claim 12,
wherein the first rail clamp, the second rail clamp, and the first rail self-centering member extend out from a top side of the first frame support arm, and
wherein the third rail clamp, the fourth rail clamp, and the second rail self-centering member extend out from a top side of the second frame support arm.

14. The rail of claim 13, wherein the self-centering rail comprises a bottom side that is opposite the top side of the first frame support arm and opposite the top side of the second frame support arm, and wherein the bottom side of the self-centering rail comprises a generally semi-circular cross-sectional geometry configured to receive a torque tube.

15. The rail of claim 12, wherein each of the first rail clamp and the second rail clamp comprise teeth members, and wherein each of the third rail clamp and the fourth rail clamp comprise teeth members.

16. The rail of claim 12,
wherein the first rail clamp is radially spaced apart from the first rail self-centering member to define a first landing surface, at the first side portion, radially between the first rail clamp and the first rail-self centering member, and
wherein the third rail clamp is radially spaced apart from the second rail self-centering member to define a second landing surface, at the second side portion, radially between the third rail clamp and the second rail self-centering member.

17. The rail of claim 16,
wherein the first frame support arm terminates at a first floating end that defines an outside bound of the first side portion, and wherein the first rail-self centering member is closer to the first floating end than is the first rail clamp, and
wherein the second frame support arm terminates at a second floating end that defines an outside bound of the second side portion, and wherein the second rail self-centering member is closer to the second floating end than is the third rail clamp.

18. A method for coupling a first solar module frame and a second solar module frame to a self-centering rail, the method comprising the steps of:
placing the first solar module frame at a first side portion of the self-centering rail with first self-centering member alignment;
moving the first solar module frame relative to the self-centering rail to engage one or more rail clamps at the first side portion of the self-centering rail to the first solar module frame;
placing a second solar module frame at a second, opposite side portion of the self-centering rail with second self-centering member alignment; and
moving the second solar module frame relative to the self-centering rail to engage one or more rail clamps at the second side portion of the self-centering rail to the second solar module frame.

19. The method of claim 18,
wherein placing the first solar module frame at the first side portion of the self-centering rail with first self-centering member alignment comprises placing the first solar module frame at the first side portion of the self-centering rail with a first frame self-centering member at the first solar module frame aligned with a first rail self-centering member at the first side portion of the self-centering rail, and
wherein placing the second solar module frame at the second side portion of the self-centering rail with second frame self-centering member alignment comprises placing the second solar module frame at the second side portion of the self-centering rail with a second rail self-centering member at the second side portion of the self-centering rail.

20. The method of claim 19,
wherein placing the first solar module frame at the first side portion of the self-centering rail with first self-centering member alignment further comprises placing the first solar module frame at a first landing surface that is at the first side portion and spaced radially between the one or more rail clamps and the first rail self-centering member at the first side portion, and
wherein placing the second solar module frame at the second side portion of the self-centering rail with second self-centering member alignment further comprises placing the second solar module frame at a second landing surface that is at the second side portion and spaced radially between the one or more rail clamps and the second rail self-centering member at the second side portion.
